(19) United States
(12) Patent Application Publication
(10) Pub. No.: US 2003/0053580 A1
(43) Pub. Date: Mar. 20, 2003

(54) Process for modelling photons, protons, neutrons atoms and the universe

(76) Inventor: John R. Ross, Del Mar, CA (US)

Correspondence Address: Ross Patent Law Office, P.O. Box 2138, Del Mar, CA, 92014, US

(21) Appl. No.: 10/251,577

(22) Filed: Sep. 21, 2002

Related U.S. Application Data
(63) Continuation-in-part of application No. 10/161,823, filed on Jun. 3, 2002.
Application No. 10/161,823 is a continuation-in-part of application No. 09/008,297, filed on Jan. 16, 1998, now abandoned.

(51) Int. Cl. G21G 1/00

(52) U.S. Cl. 376/156

(57) ABSTRACT

Processes for modeling photons, electrons, protons, neutrons and atomic nuclei and processes for analyzing light and other radiation, subatomic particles, atoms, molecules and the entire universe and its evolution. The present invention describes two new “things” that are offered as the basic building blocks of everything in the universe. These things are called “trons”. There are two types of trons, a plus tron and a minus tron. Trons have no mass but they have a charge equal to the electron charge of about +1.6×10⁻¹⁹ Coulomb for the plus tron and about −1.6×10⁻¹⁹ Coulomb for the minus tron. Six trons (such as the trons making up three photons [each photon comprised of a plus tron and a minus tron] combine to produce a single positron and a single negatron. The positron is modeled as a minus tron orbited by two plus trons and a negatron (the negative electron) is modeled as a single plus tron orbited by two minus trons. A model of a proton is proposed. A positron (or a plus tron) is orbited by two negatrons in orbits so tight that the orbit speeds of the negatrons is very close to the speed of light causing increases in the mass of each of the electrons (about 900 times) sufficient to approximately match the known mass of the proton of about 1.67×10⁻²⁷ kg. Two more positrons orbit the center threesome farther out at radii corresponding to the known proton radius. Thus, the three positrons and the two negatrons give the proton its mass of 1.67×10⁻²⁷ kg and its charge of plus one. In some models the positrons and negatron in nuclei are modeled as having captured a neutrino.

This Application is a Continuation-in-Part Application of Ser. No. 09/908,297, filed Jul. 17, 2001 and Ser. No. 10/161,823 filed Jun. 3, 2002. This invention relates to processes for analyzing nature, for modeling light, atomic and subatomic particles and their inter-reactions, and for modeling the universe and its evolution.

### BACKGROUND OF THE INVENTION

What We Are Made Of

Since civilizations first developed the smartest men in the world have sought to explain what we and the rest of the universe are made of. Scientist have discovered that the observable universe seems to be comprised of atoms each of which comprises a nucleus having a positive charge surrounded by one or more electrons each having a negative charge. There is general agreement among leading nuclear scientists that the nuclei of all atoms except H¹ consist of protons and neutrons. (The H¹ isotope has only a single proton and no neutron in the nucleus. The nuclei of the H² and H³ isotopes of hydrogen contain one and two neutrons respectively in addition to a single proton.) In prior art models charge neutral atoms have a number of negative electrons surrounding the nucleus equal to the number of protons in the nucleus and that number determines to chemical properties of the atom. Scientists generally believe that substantially all of the hydrogen in the universe was created shortly after a “big bang” which occurred at the origin of the universe and that some helium was also created during this very early stage of the evolution of the universe by the fusion of hydrogen atoms. There is a generally accepted belief that all other naturally occurring elements in the universe were created by fusion processes in large stars which later on explode to scatter the elements widely in the universe. These elements then later collect together to form objects like planets.

Electrons—Positrons and Negatrons

The word “electron” can be used to refer to only negative electrons or it can be used more generally to refer to either negative or positive electrons. Most of us are very familiar with negative electrons which orbit atomic nuclei. A “positron” is a positive electron. Another name for the negative electrons is “negatron”. A positron has a mass equal to the mass of a negative electron and a charge opposite that of the negative electron but equal in magnitude. When the term “electron” is used later in this specification, its meaning will be clear so long as the reader understands that the word has these two possible meanings.

The Size of Things

Experiments indicate that the size (distance across) of a typical atom is about 10⁻¹⁰ meter. The size of the nucleus of a typical atom (such as sodium with 26 proton and 26 neutrons) is about 10⁻¹⁴ m or about 1/10,000 the size of the atom. The size of a proton is about 10⁻¹⁵ m. The size of an electron is not known for certain but scattering experiments indicate that electrons are smaller that 10⁻¹⁸ m, and some sources indicate that they may be point-like. A diameter of 10⁻¹⁸ would make the electron about 1,000 times smaller than a proton. Its mass is about 1800 times smaller than the mass of a proton.

Charges

A negative electron (negatron) has a negative charge of about −1.6×10⁻¹⁹ Coulomb and a positive electron has a positive charge of about +1.6×10⁻¹⁹ C. The prior art teaches that a proton has a positive charge of +1.6×10⁻¹⁹ C. Since neutral atoms have an equal number of positive protons in the nucleus and surrounding negative electrons (negatrons); at distances substantially greater than atomic dimensions, the neutral atom has no charge that is apparent to us.

Photons

In the prior art a photon is believed to be a quantum of electromagnetic radiation. A photon has energy equal to its frequency multiplied by Plank's constant. A photon is believed to be a stable elementary particle of zero charge traveling at the speed of light. Virtual photons are believed to be exchanged between charged particles and are believed to carry electromagnetic force. The photon's energy is equivalent to mass according to Professor Einstein's famous equation, E=mc².

Creation of Mass

Pair production is an event in which a gamma ray photon with energy in excess of 1.02 MeV interacts with matter to create a negatron-positron pair. The “rest mass” of a negatron is 9.1100×10⁻³¹ kilograms that in energy units is equal to about 0.51 MeV. The rest mass of the positron is exactly the same as that of the negatron. It is also known that the combination of a positron and a negatron results in the annihilation of both of them with the release of two high-energy photons. This creation and annihilation is well documented, but the prior are does not provide a good explanation as to what actually takes place in either case.

Composition of Little Things

The prior art does not provide a good physical description of either photons or electrons. Photons are treated as particles in some cases and as waves of electromagnetic radiation in other cases. There have even been attempts in the prior are to apply wave characteristics to electrons. Electrons are normally treated as charged particles; however, most modem descriptions of atoms treat the electrons in the atoms as if they were some sort of cloud orbiting the nuclei.

Quarks

Modern nuclear scientists have tried to explain the structure of protons and neutrons. There is a general belief that protons and neutrons are comprised of particles they call “quarks”. They think that there are various types of quarks including “u-type” quarks and “d-type” quarks. The idea is that protons and neutrons are made up of three quarks each. The proton is supposed to be comprised of two u-type quarks and one d-type quark. The neutron is supposed to be comprised of two d-type quarks and one u-type quark. Since the u-type quarks are suppose to have a charge of 2e/3 and the d-type quarks a charge of −e/3 (where e is the magnitude of the electron charge), the net charge of the proton is +e and the net charge of the neutron is zero. (See, for example, Chapter 15, pages 608-651, Modern Physics, Second Edition, Serway et al, Saunders College Publishing, for a general discussion of these issues, especially page 633.) Most leading nuclear physicists apparently have accepted this concept of quarks as truth.

Masses

As stated above, the rest mass of an electron (positive or negative) is 9.1100×10⁻³¹ kg (or 0.000911×10⁻²⁷ kg which is equivalent to 0.511 Mev). The mass of a proton at rest is about 1.6726×10⁻²⁷ kg (939.19 Mev). The rest mass of a neutron is about 1.6750×10⁻²⁷ kg (939.54 Mev). The combined mass of a proton and the mass of an electron is about 15×10⁻³¹ kg less than the mass of a neutron. According to Einstein's theory of relativity the mass of a particle increases as its velocity increases according to the following relationship:

$$m = \frac{{m}_{0}}{\sqrt{1 - {( v / c )}^{2}}}$$

where v is the velocity of the particle and c is the speed of light.

Atomic and Nuclear Forces

Forces on Orbiting Electrons

The electrical force between charged particles is governed by Coulomb's Law and is defined by the following equation:

$$F = \frac{{q}_{1} {q}_{2}}{4 π {ϵ}_{0} {r}^{2}}$$

The ratio 1/4πe₀=9.0×10⁹ Nm²/C² and the radius r of the hydrogen atom is about 5.3×10⁻¹¹ m. Therefore, (making the assumption that the electron is orbiting at the outer region of the atom and the proton is at the center) the attractive force between the proton and the electron in the hydrogen atom is about:

F=8.2×10⁻⁸N

The electron is not pulled into the nucleus. Why this is so is not completely understood. In the Bohr atomic model electrons are merely assumed to be confined to one of several specific obits. Another answer is that the electron orbits at an orbital velocity great enough so that the centripetal force on it exactly matches the attractive electrical force. Centripetal force is:

$$F = \frac{m {v}^{2}}{r}$$

If this is correct, the velocity of the electron would be about:

$$v = \sqrt{F \frac{r}{m}} = \sqrt{\frac{( 8.2 \times {10}^{- 8} N ) ( 5.3 \times {10}^{- 11} m )}{9.1 \times {10}^{- 31} k g}}$$

$$v = 2.18 \times {10}^{6} \text{m/s} .$$

This is a very large velocity (2.18 million meters per second), almost 1 percent the speed of light. In any event the Bohr atomic model is not currently accepted by leading physics experts. The modem thinking as stated above is that the electrons surrounding the nucleus should not be thought of as being in a defined orbit, but instead some sort of electron cloud or probability density is suggested.

Experiments have shown that the exponent of r (i.e., 2) in the Coulomb equation is very accurately 2.0000 for dimensions down to 10⁻¹⁴ m. However, there is a current belief that in nuclei forces between charged particles do not obey this equation. (See Parker, Concise Encyclopedia of Science and Technology, 3^{rd} Ed., McGraw Hill, p. 492.)

Forces in the Nucleus

In all atoms except hydrogen atoms, there are multiple protons closely packed in the nucleus along with a roughly equal number of neutrons. Thus, these protons are believed to exert tremendous repulsive forces against each other as suggested by the following example of two protons separated by 4.0×10⁻¹⁵ m, which is a typical nucleus dimension:

$$F = \frac{{q}_{1} {q}_{2}}{4 {πϵ}_{0} {r}^{2}} = \frac{( 9.0 \times {10}^{9} N {m}^{2} \text{/} {C}^{2} ) {( 1.6 \times {10}^{- 19} C )}^{2}}{{( 4.0 \times {10}^{- 15} m )}^{2}}$$

$$F = 14 N$$

A force of 14 N is equivalent to about 3.2 pounds, this force acting on the two protons each of which has a mass of only 9.1×10⁻³¹ kg should cause the protons to fly apart with enormous velocities. This typically does not happen. There is a current belief among the most knowledgeable nuclear scientists that there must be some other force acting in the nucleus to hold it together. Scientists call this force the “strong force”. The Applicant is not aware of any specific proof of this “strong force”. Nevertheless most leading nuclear scientists apparently have accepted this concept of this strong force.

Neutrinos

Neutrinos are believed to be tiny neutral particles of either zero mass or almost zero mass with no charge. There are supposed to be an enormous number of them. Some scientists estimate that billions of them generated in our sun pass through our bodies each second. They are believed to be generated as a consequence of nuclear fusion and of the ones that head out in the direction of earth nearly all of them pass right through it and continue on out through the universe. Neutrinos are very hard to detect; however, scientists believe they have detected a few of them in large underground tanks. Apparently they (in 1987) detected a few neutrinos that had traveled 170,000 light years to our earth from an exploding super nova.

Magnetism and Gravity

We are very well aware of the force of gravity which holds us to the earth and keeps the earth in its orbit about our sun. And we can feel magnetic forces when we use a little magnet to hold our kid's pictures tightly against the refrigerator door. However, to my knowledge there is not available in the prior is a good basic explanation for what makes these forces.

Unanswered Physics Questions

As additional background for the present invention Applicants includes the following excerpts from the very popular physics set, Feynman, Lectures on Physics, Addison Wesley, Vol. II, p 1-2, 8-6&7, 20-9&10:

“What holds the nucleus together?” In a nucleus there are several protons, all of which are positive. Why don't they push themselves apart? It turns out that in nuclei there are, in addition to electrical forces, non-electrical forces, called nuclear forces, which are greater than the electrical forces and which are able to hold the protons together in spite of the electrical repulsion. The nuclear forces, however, have a short range—their forces fall off much more rapidly than 1/r². . . . We may ask, finally, what holds a negatively charged electron together (since it has no nuclear forces). If an electron is all made of one kind of substance, each part should repel the other parts. Why, then, doesn't it fly apart? But does the electron have “parts”? Perhaps we should say that the electron is just a point and that electrical forces only act between different point charges, so that the electron does not act upon itself. Perhaps. All we can say is that the question of what holds the electron together has produced many difficulties in the attempts to form a complete theory of electromagnetism. The question has never been answered. (Emphasis added.)

[A] big program was started for the study of the scattering of protons, in the hope of finding the law of force between [neutrons and protons]; but after thirty years of effort, nothing has emerged. A considerable knowledge of the force between proton and proton has been accumulated, but we find that the force is as complicated as it can possibly be. What we mean by “as complicated as it can be” is that the force depends on as many things as it possibly can. . . . There is, however, one important way in which the nucleon forces are simpler than they could be. That is that the nuclear force between two neutrons is the same as the force between a proton and a neutron, which is the same as the force between two protons! If, in any nuclear situation, we replace a proton by a neutron (or vice versa) the nuclear interactions are not changed. The “fundamental reason” for this equality is not known.

I have no picture of [the] electromagnetic field that is in any sense accurate. I have known about the electromagnetic field a long time—I was in the same position 25 years ago that you are now, and I have had 25 years more of experience thinking about these wiggling waves. When I start describing the magnetic field moving through space, I speak of the E- and B fields and wave my arms and you may imagine that I can see them. I'll tell you what I see. I see some kind of vague shadowy, wiggling lines—here and there is an E and B written on them somehow, and perhaps some of the lines have arrows on them—an arrow here or there which disappears when I look to closely at it. When I talk about the fields swishing through space, I have a terrible confusion between the symbols I use to describe the objects and the objects themselves. I cannot really make a picture that is even nearly like the true waves. So if you have some difficulty in making such a picture, you should not be worried that your difficulty is unusual.

The Need

Prior existing descriptions of the basic building blocks of the universe are not satisfactory. What is needed is a simpler unifying process for describing of the particles making up the universe, processes for modeling photons, protons, neutrons, nuclei, atoms and the universe and techniques and processes for confirming or disproving this simpler unifying description.

### SUMMARY OF THE INVENTION

The present invention provides processes for modeling photons, electrons, protons, neutrons and atomic nuclei; processes for analyzing light and other radiation, subatomic particles, atoms, molecules and the entire universe, its evolution; and possibly processes for analyzing all forces of nature.

Basic Building Blocks of the Universe

The present invention describes two new “things” that are offered as the basic building blocks of everything in the universe. I call these things “trons”. There are two types of trons, a plus tron (which I also sometimes call a “petron”) and a minus tron (which I also sometimes call a “netron”). Trons have no mass but they have a charge equal to the electron charge of about +1.6×10⁻¹⁹ Coulomb for the plus tron and about −1.6×10⁻¹⁹ Coulomb for the minus tron. The charge on each tron results in an electric force field that travels out from the tron with a velocity substantially in excess of the speed of light. This force field has the shape of the surface of an expanding sphere, expanding at this velocity faster than the speed of light. (The velocity is, according to preferred models, a fixed velocity, but I am not certain exactly what it is. In some of my preferred models it is assumed to be 3 c (i.e., three times the speed of light, about 9×10⁻⁸ m/s.) The magnitude of the force field decreases as the inverse square of the distance from the point from which it started expanding. The field from an individual tron is attractive for unlike trons and repulsive for like trons. All trons are pushed and pulled by these expanding force fields. Having no mass these trons move at the velocity of the net forces acting on them, like a surfer on one or more waves or a water skier being pulled by a boat and pushed about by wind produced waves and by wakes from the boat. The trons can travel faster than the speed of light and usually (maybe always) do. They can even travel faster than the 3 c speed of the force fields they produce since a given tron can be acted on by force fields from more than one tron, each pushing or pulling the tron in a different direction at a speed of 3 c. When a tron is accelerated to velocities greater than 3 c then slows down it may be pushed along at a speed of 3 c by its own force field expanding out from earlier times and locations on a trailing portion of its path.

With this basic model, all of the elements of the universe (including photons, electrons, protons, atoms, and molecules) can be described and explained. Questions such as the ones raised by Dr. Feynman quoted in the background section can now be simply answered. Models of exotic things we know very little about such as neutrinos can be described with this basic model. This basic model proposed and claimed in this application also seems to be consistent with all known and accepted physics principals and the results of experiments relating to particle physics, magnetism, optics, various forms of energy, fusion and fission. In many cases, however, this model provides an explanation for a particular result which is substantially different from the prior art explanation. Some physics principals which in the past have been shown to give good results but do not seem logical (such as the uncertainty principal [which, by the way, Dr. Einstein did not accept]) may be explained based on or may be derivable from this extremely simple basic model. (Most of these tasks—such as deriving Dr. Schrödinger's uncertainty principal from models described herein—have been left by the inventor for others to have fun with.)

Photons

In a preferred embodiment of this invention photons are modeled as a single plus tron and a single minus tron orbiting helically at the photon frequency about a common center in an orbit plane and being driven, at a speed of light in the photon direction perpendicular to the orbit plane, by the repulsive Coulomb forces of each of the charges on itself with each tron held in its orbit by the attractive force of the other tron. The two trons having zero mass are traveling in their helical paths substantially faster than the speed of light, and faster even than the expanding force fields that they generate. I have not figured out for certain the orbit diameter of the photon, but in one model it is assumed to be equal to the wavelength of the light the photon is a part of. And this results (according to my calculations) in a speed of the expanding force from the trons of 3 c.

Electrons—Positrons and Negatrons

Six trons, three plus and three minus (such as the trons making up three photons [remember, each photon is comprised of a single plus tron and a single minus tron] combine to produce a single positron and a single negatron. The positron is modeled as a minus tron orbited by two plus trons and a negatron (the negative electron) is modeled as a single plus tron orbited by two minus trons. In the positron and the negatron the tron Coulomb forces propel the two orbiting trons (having the same sign) in two perfect circles on the surface of a perfect sphere surrounding the inner tron. This model suggests an explanation for the enormous stability of electrons and positrons in all situations except when one meets the other. When a positron and a negatron meet each other they annihilate each other releasing the trons which pair up to produce photons that shoot off at the speed of light; otherwise, they are virtually indestructible. Remember, Dr. Feynman could not understand why electrons do not “fly apart”. Read on to find out why they don't.

Protons and Neutrons

Protons and neutrons, like everything else in the universe are modeled as comprised of trons. In a preferred embodiment a proton model is proposed that is comprised of electrons (i.e., three positrons and two negatrons). (Some models include captured neutrons.) A positron is orbited by two negatrons in orbits so tight that the orbit speeds of the negatrons is very very close to the speed of light causing increases in the mass of each of the electrons (about 900 times) sufficient to approximately match the known mass of the proton of about 1.67×10⁻²⁷ kg. Two more positrons orbit the center three-some farther out at radii corresponding to the known proton radius. Thus, the three positrons and the two negatrons give the proton its mass of 1.67×10⁻²⁷ kg and its charge of plus one. The plus one charge is also produced by adding up the eight plus trons and the seven minus trons contained in the three positron and two electrons which make up the proton. In another embodiment the proton is modeled with a plus tron in the middle, so that the proton is comprised of a plus tron in the middle with two negatrons and two positrons in orbit. The neutron is simply a proton with a negatron in very close orbit. In another proton model the central particle is a plus tron instead of a positron.

Atomic Nuclei

This preferred model models atomic nuclei as protons and neutrons held together at nuclear distances in Coulomb force wells. Since, at nuclear distances, the proton plus one charge is at least 13 separate discrete charges grouped into five separate discrete charges, three plus and two minus, protons and neutrons can orient themselves so that they attract each other and repel each other (depending on orientation and distance of separation) producing force wells with strong Coulomb forces (not “the strong force”). On both sides of the wells, the protons repel each other. The neutron is indifferent (neither attracted or repelled from charged particles) at distances longer than nuclear distances, but is attracted to protons and other neutrons in specific configurations at atomic distances and is repelled from both protons and other neutrons if it gets too close.

Atoms and Molecules

The model of the present invention proposes in accord with prior art thinking that atoms and molecules are made up of protons and neutrons in the nuclei with electrons in orbits. The larger atoms are produced by the fusion of nuclei of smaller atoms or the capture of neutrons, again, in accordance with prior art thinking.

Electric Current

The present invention proposes that the flow of current in both direct-current circuits and in alternating current circuits is for the most part the flow of plus trons and minus trons, not electrons and holes. Because of their zero mass and point volume they can travel through a copper wire at a large fraction of the vacuum speed of light. However, when they arrive at their destination each one contributes a charge equal to a negative electron or an opposite positive charge.

Thermal Energy

The present invention predicts that thermal processes are for the most part produced by action of plus and minus trons that are temporally captured within atomic and molecular structures. However, according to this model trons are good at escaping and do so in processes we know as conduction, convection and radiation. It is the flow of trons (either as radiant heat flow [thermal photons] or as conduction and convection) that we perceive as heat energy flow.

Neutrinos

Neutrinos travel at the speed of light, have no charge and a very small or zero mass. They thus could be modeled as a plus tron and a minus tron orbiting each other in a double helix like the photon but with a much smaller orbit. However, a better model seems to be a four-tron neutrino model. Here two like trons orbit two opposite trons. For example in one model two negative trons orbit two positive trons in an orbit plane moving at the speed of light. The two negative trons map out a very tight double helix as their own force fields from their trails push them in a direction perpendicular to the orbit plane at the speed of light. The negative trons are kept in the very tight double-helix path by the attraction of the two positive trons which in turn are trapped inside the double helix path, one positioned slightly in front of the orbit plane of the two orbiting trons and one positioned just behind the orbit plane of the orbiting trons. (In another neutrino model two plus trons orbit two negative trons.) In a preferred model a neutrino may be captured by an electron to form a heavy electron which is in turn can be captured by a proton to form a neutron. The neutron can be stable if it can get inside of a nucleus within a very few minutes. Otherwise it decays within a few minutes into a proton releasing the heavy electron, which in turn decays to an electron releasing the neutrino which then goes on its way at the speed of light. In other models each electron (plus and minus) in atomic nuclei has captured a neutrino.

Magnetism

Applicant speculates that the magnetic forces we experience are the result of the flow of trons along what we have called magnetic lines of force inside of and beyond magnetic materials at speeds in excess of the speed of light. According to this model the magnetic fields of the earth results from the flow of these trons through the earth, exiting near one of our earth's poles and entering at the other. The round trip may require less than one second at tron speed, estimated at 3 c

Gravity

Applicant has not been able to develop a complete explanation for gravity based on the tron models. However, Applicant believes that the gravitation force must be derived from the Coulomb electrostatic force of the trons making up matter. Applicant believes that gravity is a manifestation of these electrostatic tron forces that are not quite perfectly balanced resulting in the mutual attraction of matter (according to the laws of gravity) at a range of distances larger than molecular distances and smaller than galactic distances.

Antimatter

The models of the present invention easily accommodate antimatter particles of all types. The modeling of the antimatter particle corresponding to any of the above described particles is done by merely switching the plus trons in the particle with the minus trons. The electron and the positron have already been described. The anti proton has an electron (or a minus tron) in the center orbited closely by two positrons and further out by two more electrons. The anti neutrino is just the opposite of the neutrino.

Models

The present invention provides physical and computer models representing trons, photons, electrons, nuclei atoms and molecules. These models can be combined to describe anything in the universe and the universe itself.

Analytical Process

Preferred embodiments of the present invention include processes for analyzing forces acting in atomic nuclei. Embodiments of the present invention can be utilized to analyze hydrogen thermonuclear reactions. The present invention also provides a process for attempting to create protons is in a particle accelerator. The present invention also provides models for analyzing electric current flow, heat flow and electromagnetic radiation. Computer models based on embodiments of the present invention may be extremely valuable for examining a wide range of natural and unnatural phenomenon from the interaction of subatomic particles to nuclear reactions to the big bang to the evolution of the universe. In fact, if the model and processes of the present invention turn out to be a correct representation of these subatomic particles and charges, all physics and chemistry books and all methods and processes for examining structures, electric currents and forces at atomic and molecular distances will need to be revised in accordance with the discoveries described herein.

Unanswered Questions

The present invention provides a new method of analyzing the universe and everything in it. The model provides simple explanations for many known phenomenon for which previous explanations were unsatisfactory. These models for the most part are based on thought experiments not actual experiments and Applicant does not have absolute proof of the correctness of the models and recognizes that many of the proposed models are not precise. The Applicant recognizes that people skilled in this art may be able to show immediately that some embodiments of this invention proposed herein are partly or completely erroneous. Applicant encourages criticism of and refinements to the models. If the basic concept of a universe made from plus and minus trons turns out to be correct, it could be an important advancement in human knowledge about the universe we live in. As set forth herein the entire universe and everything in it can be modeled as comprised of these two simple trons; however, this specification does not explain the origin of the trons. This huge question is left unanswered. Maybe God made them a long time ago.

### BRIEF DESCRIPTION OF THE DRAWINGS

FIG. 1 is a representation of a proton.

FIG. 2 is a representation of a neutron.

FIG. 3A is a representation of an alpha particle minus two negatrons.

FIG. 3B is a representation of an alpha particle.

FIG. 4 is a representation of a portion of an alpha particle.

FIG. 5 is a graph showing forces between particles in a nucleus according to a Ross model.

FIGS. 6A, B, C, D and E are drawings showing features of trons.

FIG. 7 shows a photon in flight.

FIGS. 7A, 7B, 7C and 7C show features of a photon.

FIG. 8 shows a pair production from 6 trons.

FIGS. 9 and 10 show electron models.

FIG. 11 is a sketch of a neutrino.

FIGS. 11A, 11B and 11C show models of an electron, a neutrino and a heavy electron.

FIG. 12 shows a technique for providing a possible explanation of magnetism.

FIG. 12A shows the magnetic field surrounding the earth.

FIG. 13 shows a technique for providing a possible explanation of gravity.

### DETAILED DESCRIPTION OF PREFERRED EMBODIMENTS

The present invention can be described by reference to the drawings.

The Universe may be Modeled as Nothing but a Very Large Number of Plus and Minus Charges

The present invention is based on Applicant's discovery that the universe may be modeled as completely made of nothing but a very large number of point charges of zero mass, the point charges being either plus or minus. Applicant calls the charges “trons”. Each plus tron (also called by Applicant a “petron”) has a charge equal to the well-known net charge on a proton or a positron, i.e., a charge of about +1.6×10⁻¹⁹ C, and each minus tron (also called a netron) has a charge equal to the net charge on a negative electron, i.e., a charge of about −1.6×10⁻¹⁹ C.

Trons

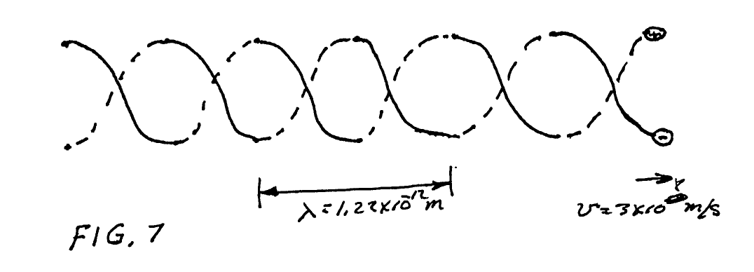

FIG. 6A is a representation of a tron at rest (although trons normally are not at rest [maybe never]). The tron is designated 20. Each tron exerts attractive and repulsive force on all other trons in the universe. However, these forces do not act instantly at a distance. In this model the forces, both attractive and repulsive, travel out together from the tron at a velocity that is, in preferred models, a specific velocity in excess of the speed of light. It is this velocity of the expanding force field that determines the speed of light which we measure. In one preferred model the force field travels out from each tron in the shape of the surface of an expanding sphere which expands at a velocity of 3 c or three times the vacuum speed of light. Thus concentric circles 22 around the point charge represents these force effects and each circle represents a time increment. They are shown in two dimensions but the reader should understand that the forces travel spherically. The forces exerted between two trons obey the Coulomb Law, F=q²/r². The force is attractive if the trons have opposite signs and repulsive if they have the same sign. Trons are almost always in motion, each tron being pushed about by the net forces on it, including its own repulsive force if they try to slow down after having been accelerated to a velocity faster than the expanse of its own expanding force field. Trons can travel faster than the speed of light and typically (possibly always) do. FIG. 6B shows a tron moving at a speed of 3 c being pushed by its own force field. The tron at time zero (now) is shown at 24. The distance between spots on the drawing represents distance traveled in a time interval Δt. The spot 26 represents the position of the tron at t=−9ΔT and the largest circle 28 represents the expanding force at t=0 resulting from forces emanating from the tron at t=−9. As indicated by arrows 30 the force is repelling for like trons and attractive for opposite trons. The string of arrows at 32 show that the attractive force of a moving tron can take on an arc shape. The reader should note that only nine circles are shown but the number of circles could be continued infinitely. The reader should also note that the tron being pushed by its own repulsive force exerts no force, attractive or repulsive on the upstream side of plane 34.

What Happens when Opposite Trons Meet

According to this preferred model, an intersection of two opposite trons often results in the formation of a photon as shown in FIG. 6E. FIG. 6C is a depiction of two opposite trons traveling in opposite directions, each with a speed of at least 3 c. The minus tron first feels the attraction of the plus tron when the plus tron is at location 36A and when the negative tron in located at 38A but the attractive force of the plus tron which the minus tron feels emanated from the plus tron when it was located at 36B. The two trons rapidly form into a circle each being attracted to the other at a point back on the trail of the other. FIG. 6D depicts two trons in orbit in a circle 40 around a common center. The dots on the circle represent the trail of the two trons at nine time intervals. The position of each tron at t=0 is shown at 40A and 40B. Circles 42 show the cross section of the spherical force surfaces of the 40B tron and arrow 44A shows the 40A tron being attracted to the point where the tron 40B was located at t=−9.

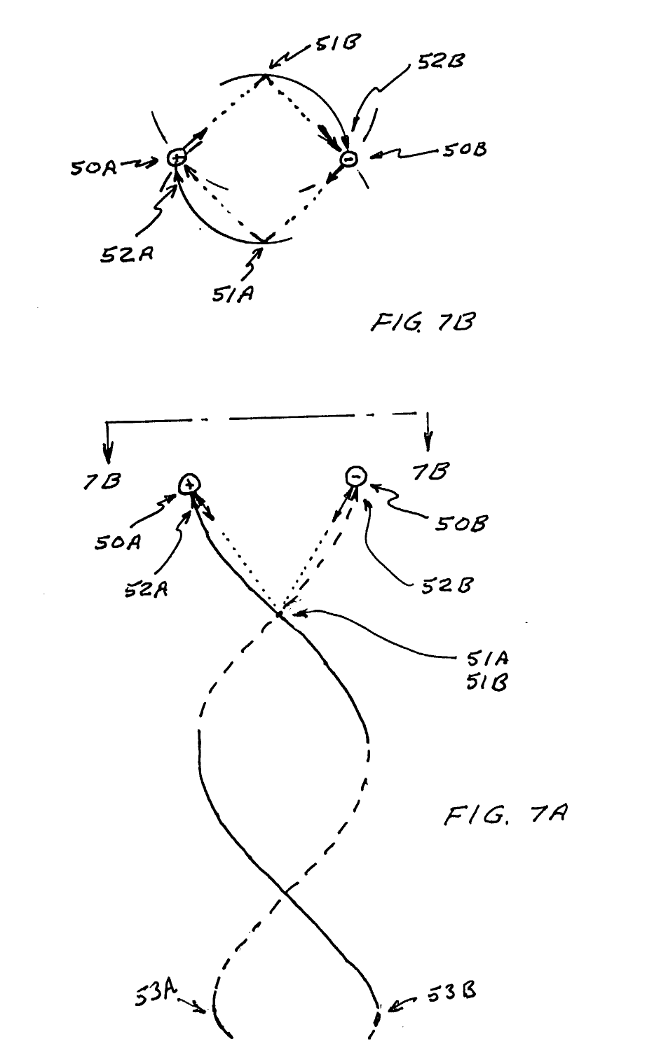

The two trons do not meet. The reason, referring back to FIG. 6C is that at location 38D the plus tron intersected its own repulsive force that flowed out from itself when it was at location 38B. This restricts the plus tron from approaching closer to the negative tron. It also applies a new force pushing the plus tron in a direction out of the page. Similarly, the minus tron at location 38E feels a repulsive force from itself forcing it to keep its distance from the plus tron and also pushing it in a direction out of the page. Thus, photon is formed. FIG. 6E is a cross section view of the photon in the plane of obit which is moving at a velocity of c. FIG. 7 shows a side view of the two trons which have just joined together to create this photon. Applicant has depicted the photon with a wavelength of λ=1.22×10⁻¹² m. Like all photons, it is moving with the speed of light, c=3×10⁸ m/s. The reader should note that if the orbit plane of the two trons has a velocity c (as it must) then each tron must be moving substantially faster than c along their helical path.

The Helical Path

Now we have an interesting geometry problem. This model assumes a double helical path of the two trons making up this photon. Plus, we know the speed of the orbit plane. It is c. And we are assuming for this example that we know the wavelength (e.g., λ=1.22×10⁻¹² m). However, we do not know the orbit diameter and we do not know the speed of the force field of the tron. If we knew either we could calculate the other. For example, lets refer to FIG. 7C that is a view facing an on coming photon of wavelength λ and speed c, and FIG. 7D that is a side view of the photon showing its path for two wavelengths. Plus tron A is attracted toward location E on the trail of minus tron B and plus tron A is repelled away from location D on its own trail. Minus tron B is attracted toward location D on the trail of minus tron A and minus tron B is repelled away from location E on its own trail. Therefore, the period of the photon must be:

$$T = L / Q = \sqrt{{( π D )}^{2} + {λ}^{2}} / Q$$

$$T = 4 K / G = 4 \sqrt{{( \frac{λ}{4} )}^{2} + {( \frac{D}{\sqrt{2}} )}^{2}} / G$$

$$T = λ / c$$

where: C is the speed of light, L is the distance traveled by each tron on its helical path in one period, Q is the tron speed, K is the distance between points E and B, between E and A, between D and B and between D and A, and G is the speed of the force fields expanding out from the trons. Therefore, solving for Q and G we find:

$$Q = ( \frac{\sqrt{{( π D )}^{2} + {λ}^{2}}}{λ} ) ( c )$$

$$G = \sqrt{1 + \frac{8 {D}^{2}}{{λ}^{2}}} ( c )$$

If we assume that D=λ, we have:

Q=\sqrt{λ²+1}(c)=3.29 c

G=3 c=9×10⁸ m/s.

What if Trons Meet

What if opposite trons meet head on? Applicant is certainly not certain. I speculate that they either never meet or if they do that they pass through each other. Since trons are point charges pushing themselves at speeds faster than the speed of light (which is awfully fast for a massless point) the probability of a collision should be low. Further, there is no attraction in the directly ahead direction. In addition, if two opposite trons each going at the speed of, for example 3 c, were to collide, each may be attracted to a point behind the other. This may cause them to pass through each other. My speculation is that all of the trons produce or released during the big bang are still with us and will be with us until the end of the universe or even beyond that!

The Photon

As stated above, FIG. 6E is a drawing representative of a photon with the plane of the page corresponding to its orbit plane and the plane of orbit is moving at a speed of light. The photon in this model consists of a plus charge 30 equal to about +1.6×10⁻¹⁶ C and a minus charge 32 of about −1.6×10⁻¹⁶ C. This particular photon is a 1.02 Mev pair production photon. This energy (1.02 Mev) corresponds to a photon frequency of:

f=E/h=1.02 Mev/4.14×10⁻²¹ Mev.s

f=2.46×10²⁰/s.

It has a wavelength λ=1.22×10⁻¹² m, and a period, T=1/f=4.08×10⁻²¹ sec.

FIG. 7 shows a side view of the photon trail through the universe. The tracts on the reader's side of the trail are shown solid and the other side is shown dashed. The trail resembles a barber pole with each of the two orbiting charges completing an elliptical orbit in a time, T=4.08×10⁻²¹ sec, with the two orbiting charges progressing forward, in the direction of the photon perpendicular to the plane of orbit, at 3×10⁸ m/sec and moving forward 1.22×10⁻¹² m (i.e., the wavelength of the photon) each orbit. In order for the plane of the orbit to move at the speed of light, the individual trons must move faster than the speed of light. As stated above if we assume an orbit diameter equal to the wavelength then the velocity of the trons is 3.29 c. Based on these assumptions, the tron velocities are the same for all photons regardless of wavelength. Also, making the assumption that the orbit diameters equal photon wavelengths means that the velocity of the trons force field must be 3 c. Applicant does not pretend to be a mathematician and the photon diameter is a guess based on his understanding that the diameter of the smallest focal spot of light at a specific wavelength is roughly proportional to and not much different from the wavelength of the light Applicant looks forward to having his work examined by experts who can better deal with helixes and optical experts who can better apply Applicant's basic model to experimental data to determine the photon diameter as a function of wavelength. A very many of these photons apparently have traveled around the universe at the speed of light since soon after it began, gradually losing energy over the billions of years. They must be enormously stable things!

Photons are Self-Propelling

In this preferred embodiment, photons propel themselves across the universe! Based on the model, the attractive and repulsive forces travel out from the trons at three times the speed of light. Since trons have no mass any force acting on them will accelerate them instantly up to the velocity of the expanding force field or until a counter force is applied. These forces travel as an expanding sphere with the tron riding on the expanding surface. The tron may be free to move anywhere on the expanding surface and they normally slide around on the surface so that their net velocity in any single direction is much less than the velocity of the expanding force field. These forces are shown in FIGS. 7A and 7B. The two trons are shown at 50A and 50B at t=0. Their positions at t=−¼ T (i.e., ¼ period into the past) are shown at 51A and 51B and their positions at t=−T are shown at 53A and 53B. The Coulomb forces emanating from the positive tron 50A one-forth period ago at 51A pushes upward and outward on itself (tron 50A) and pulls inward and downward on tron 50B. Conversely forces from tron 50B one-forth period ago at 51B pulls downward and inward on tron 50A and pushes upward and outward on itself (tron 50B). The two trons can not escape each other because of their mutual attraction. They can not get any closer to each other because each is propelled by itself ¼ period ago. Each can not slow down due to it own repulsion. Therefore, they fly together helically through the universe until they encounter forces strong enough to disrupt their double helix relationship. Encounters with other forces often results in the trons being pushed apart corresponding to a reduction in wavelength. (Some of the photon's energy is transferred.) When the photon encounters matter, the double helix is often destroyed and the two trons are absorbed into the matter and proceed to fly around inside the matter randomly. We recognize this as heat and a see it as an increase in temperature. The matter can lose the heat when the trons drift out as conduction or convection or form into longer wavelength photons and fly off at the speed of light as radiant heat.

Absorption, Transmission and Reflection

When photons intersect with an object they either pass through, get absorbed in it or are reflected. In case of transmission and reflection the wavelength is the same out as in; therefore, there can be no loss of energy. Often the photon is absorbed in the object. In prior art analysis the photon is considered to be a bundle of energy with no charge and in the case of absorption the energy of the photon is assumed to have raised an electron in an atom to an excited state. The prior art explains that when the electron returns to its ground state through one or more jumps it creates photons and they fly out at the speed of light. The prior art does not have a good explanation as to how the atom or the electron is able to create these photons. In the present model a photon (i.e., the two orbiting charges) may be captured by an electron, or an atom or a molecule so that the photon's forward motion is stopped but the two charges continue to orbit at the same frequency while at the same time held in a dynamic Coulomb force well in the electron, the atom or the molecule. This would represent an excited state of the atom. The lifetimes of these excited states are normally very short. In most cases of absorption, the photon loses it shape (i.e. its frequency) but the two trons remain temporally attached to the atom making the atom more excited than it was, raising the temperature of the absorbing thing. In fact (as explained above) the model contemplates that in atomic and molecular structures a very large number of trons are temporally captured and that they represent heat; and explained above the trons may creep out as heat conducting or they may form into thermal photons that radiate out as thermal radiation. Normally, this as thermal radiation at a lower frequency.

Photon Models

Applicant has constructed photon models such as described in FIGS. 7A and 7B using cardboard toilet paper mandrels and also with Plexiglas tubes, string and rods. Persons skilled in computer programming could easily create 3-dimensional computer models of the photon including dynamic models in which the tron charges propel themselves (in very slow motion) at a speed representing their actual speed at a multiple of the speed of light. In these 3-dimensional models the trons could be simulated with the tron specifications given above and initially given random or other forms of motion and allowed to form themselves into photons, electrons or more complicated particles.

The Shape of the Orbits

In the preferred model discussed above, the orbit of the two-tron photon is circular, but the shape of the orbit might possibly also be modeled as elliptical with the circular orbit as a special case. Potential shapes could possibly include an extremely elliptical orbit almost linear. This may be what perfectly polarized light looks like, but Applicant thinks all photons have circular orbits in planes that move at the speed of light, but I could be wrong. The present invention on this issue is flexible. Perhaps some smart reader of this specification will be able to determine whether the orbits must be circular or that the circular orbits are merely a special case.

Creation of Mass (Energy)

In preferred embodiments of the present invention, the entire universe is built up with building blocks consisting of only plus and minus trons, neither of which has any mass. So, where does the mass come from?

Mass is a measure of inertia of a thing; i.e., its ability to resist forces. A tron exerts forces on other trons (the Coulomb force attracts or repulses) but a tron provides no resistance to forces exerted on it so long as the forces are not in conflict. It has no mass so it is pushed at the speed and in the direction of any forces applied to it. A tron can move freely in three directions; however, the tron may acquire mass once it is subjected to forces on it directed in more than three directions. Thus, when three forces are applied to a tron in different directions it can merely move in a three dimensional space in response to all three forces without providing any resistance to any of these forces. If a fourth force is exerted on the tron it must resist at least one of the four forces. Thus, the mass less tron suddenly has a mass! And therefore energy! The two mass-less trons comprising a photon are each subjected to three continuous forces according to the model shown in FIGS. 7A, 7B, 7C and 7D. Thus, a photon traveling through space has no mass; however, when a photon encounters matter and other Coulomb forces it displays mass. This mass may also be analyzed as energy. When the photon is absorbed its “mass” is added to the thing that absorbed it.

Is Our Model Consistent with Our Knowledge about Photons?

Since it represents the most basic concepts of nature, all presently known accurate physics principals must be derivable from it. We know that some things we know about photons are consistent with the model because the model was developed based on the knowledge. These include:

1) The size of the photon of the preferred models seems consistent with how closely we can focus light of various wavelengths.

2) We know that photons have no apparent charge, but photons are known to interact with matter having charges. These features are consistent with the present model where each photon has two charges of opposite sign and at distances substantially greater than the orbit diameters will cancel each other so that the photon appears to have no charge.

3) The photon has energy equal to a constant (Plank's constant) times the frequency. If a photon had a length how long would it be? One wavelength? Six wavelengths?) This model says that the photon does not have a length. The only thing it has is charge and frequency (and a corresponding wavelength) and a speed. Its frequency determines its energy.

4) Each photon has am equivalent mass (or energy) that is proportional to its frequency. If the photon is moving at the speed of light and vibrating with a frequency, then parts of it must be moving faster than the speed of light which is suppose to be impossible. How can that be. This model provides an answer. It says the trons have no mass and so they may move faster than the speed of light. Our oscillating trons create the photon's mass! Therefore, our model is consistent with known fact that the photon energy (or mass) is proportional to its frequency.

5) There never has been a good explanation as to how electricity could travel in a copper wire at a large fraction of the speed of light when it is known that the electrons travel in conductors at speeds of only a few meters or centimeters per second. Holes (whatever they are supposed to be) are thought to travel even more slowly. This model says the trons are what travel at a substantial fraction of 3×10⁸ m/s. The trons with zero mass can carry a charge at almost light speed through a copper wire. Thus, this model is consistent with our knowledge of electric current flow.

6) In a laser, a gain medium is created in excited atoms or molecules. This model explains the gain medium are temporally captured photons (i.e., the two trons continue to orbit each other but instead of being pushed forward by their own charges, but they are both held in orbit inside an atom or molecule by the forces there which overcome the photon's own driving forces). The stream of laser photons passing by applies forces which tend to orient the orbits of the two trons in the direction of the laser beam. A slight hiccup in the “excited” atom or molecule releases the photon to join the laser beam.

All of the hundreds of well established physics and optical features of photons will need to be successfully tested against this model of the photon if the model is to have general acceptance. I have lain awake many hours trying to figure out polarization based on this model. This is a tough one. One explanation which I do not like is that a polarized photon may have an orbit that is not circular. The one I like better is to tie polarization to the orbit direction. Polarization needs more work. The Applicant believes and hopes that students, professors, engineers and scientists around the world will have great pleasure in being the first to demonstrate that each of these known features are consistent with the model. All existing physics rules including Newton's, Maxwell's and Einstein's equations that work and have been used for many years in solving problems should be derivable from this preferred model if it is correct. On the other hand if the model is faulty; hopefully, it will be quickly proved faulty and forgotten.

Electrons

Continuing my effort to describe a simple universe, I have developed an electron (positron and negatron) model similar to the photon model described above and similar to the proton-neutron model described in one of the parent application (to this continuation-in-part) i.e., Ser. No. 09/908,297, submitted Jul. 17, 2001. Whereas, protons and neutrons were made of positrons and negatrons, I now have developed a model for the construction of electrons (positrons and negatrons) from the same things that make up photons, i.e., trons. This electron model was initially described in an application filed Jun. 3, 2002. Therefore, as described in the summary to this specification, everything in the universe is made of trons—and I mean everything! Everything from the light we see, the warmth we feel, the nuclei and electrons of all of the atoms in our bodies and in our galaxy and in all of the galaxies in the universe and the universe itself—all made from combinations of two tiny massless charges—amazing! But back to electrons.

For many years scientists have known that high-energy photons interacting with matter can produce positrons and negatrons. This is called pair production. Also, it is well known that positrons and negatrons will annihilate each other producing “two” high-energy photons. I am not aware of any good prior art explanation or model explaining these events. After reading this specification, one might think that it should have been obvious that given pair production and positron-negatron annihilation that electrons and photons must be comprised of the same ingredients. However, I have not seen that simple concept suggested in any of the 20 to 30 physics books that I have studied recently. That is what my preferred electron model says. One negatron and one positron is made from the six trons (i.e., the composition of three photons).

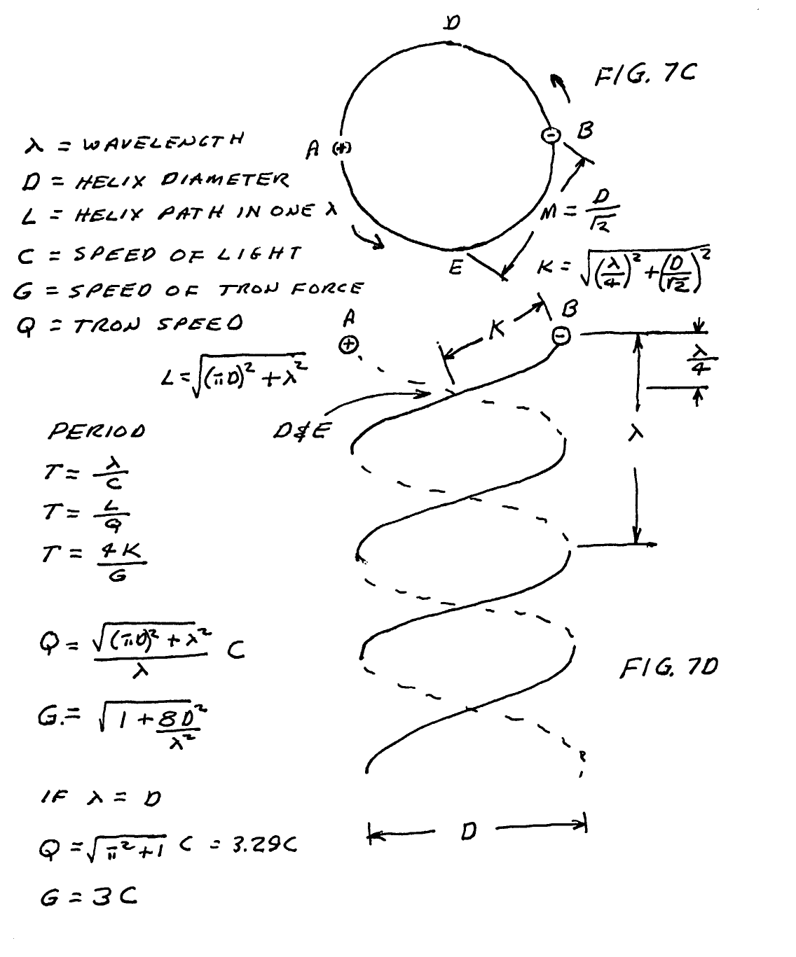

FIG. 8 shows three photons 64A, 64B and 64C combining to form a positron 65A and a negatron 65B. The vertical dashed line separates the before and after. The Applicant is far from certain exactly how these combinations takes place. According to these preferred models of electron formation most of the trons are moving faster than the speed of light before and after the formation of the electrons. In the photon model both trons in each photon are moving forward at the speed of light and in their orbit faster than the speed of light. The center tron in each electron is almost stationary (at least as compared to the orbiting trons or it may be orbiting in extremely small orbits pushed by its own repulsive force and attracted by forces from the two orbiting trons) and the two orbiting trons are orbiting at speeds faster than the speed of light.

The Electron Model

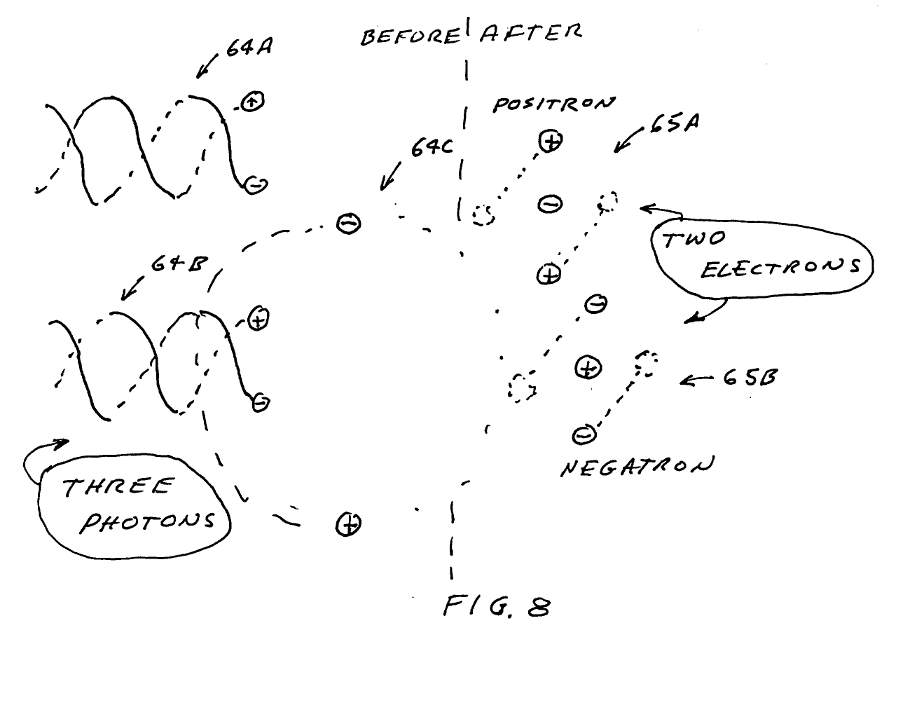

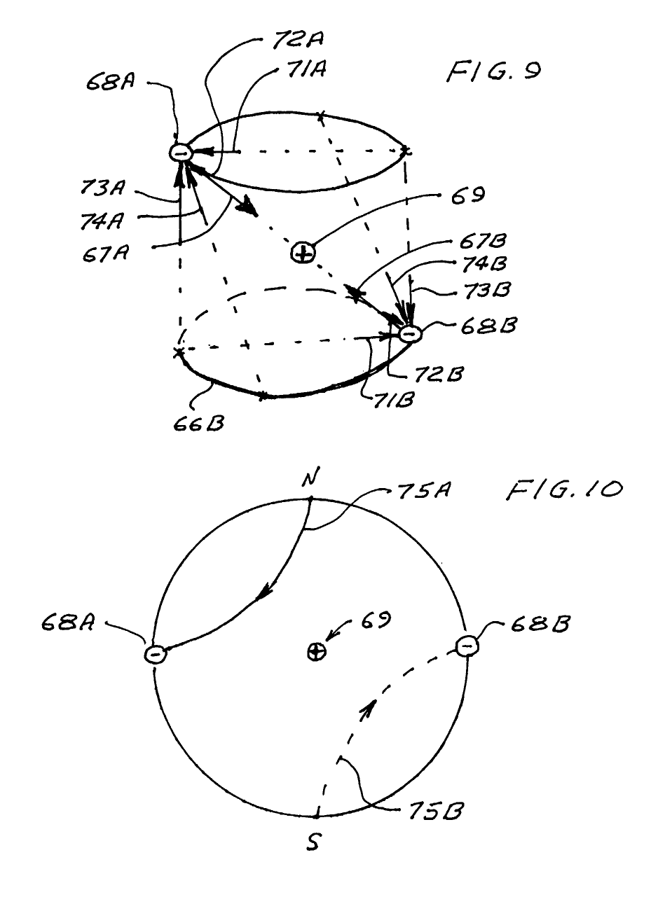

FIG. 9 is a drawing of an electron according to a preferred embodiment of the present invention. It is a drawing of a model of a negative electron 70 made by Applicant out of Plexiglas, tape and cord and 3/16 inch diameter wooden dowel rods. The cord was glued to Plexiglas sheet to represent tron orbits 66A and 66B. The dowel rods were used to represent Coulomb forces and their directions. Colored tape wound in the shape of balls was used to represent the trons. The forces are as follows: Attractive forces 67A and B are pulling the two orbiting negative trons 68A and 68B toward positive tron 69 in the center of the electron 70. Repulsive forces 71A, 71B, 73A, 73B, 74A and 74B combine to counteract attractive forces 67A and 67B and to push the negative trons in their orbits. Forces 72A and 72B prevent the orbiting trons from slowing down. Since both negative trons are traveling faster in their orbits than the speed of their expanding force fields, they are affected by their own repulsive forces from various points in their past where the repulsive forces moving more slowly (at an estimated 3 c) intersect them on their circular orbits. Each orbiting tron is also affected by the repulsive forces of the other orbiting tron also moving at the same speed in synchrony on the opposite side of electron 70. These forces are also moving at 3 c and so the forces felt appear to come from the trail of the other orbiting tron rather than the tron itself. The resulting forces push the orbiting trons endlessly along their path about the center tron. The paths in this model form perfect circles on an imaginary surface of an imaginary sphere. But the diameters of the circles are smaller than the diameter of the imaginary sphere. For example, if you think of the electron as a small Earth, and the two orbiting trons were orbiting along the equator; the subsequent path of one of the trons would follow a circular great circle route 75A over the north pole and the other tron would follow a circular great circle route 75B over the south pole. These routes are shown in FIG. 10. The two arcs show the immediately preceding half circle for each Tron. The path of 68A was on the front of the sphere and the path of tron 68B (shown dashed) was on the back half of the sphere. The central ton 69 is located approximately in the center of the sphere being attracted by equal and opposite attractive forces from the trails of the orbiting trons. In one model the central tron is virtually stationary in the center of the electron. In another model the central tron is allowed to orbit in an extremely tight orbit at speeds equal to or greater than 3 c being pushed by its own repulsive force.

This model of the electron provides an explanation as to why the electron is so stable. I have not yet been able to figure out the radius of the electron, but I believe its radius should be easy to figure out by people with a little better grasp of geometry and forces in motion than I have. My model tells us, however, that it must be much smaller than the proton that has a diameter of about 10⁻⁵ m. My guess is that the radius is less than 5×10⁻¹⁹ m. This means that the forces holding the electron together and keeping it from collapsing may be millions or billions of Newtons! This is the answer to Professor Feynman's question referred to in the Background section relating to why the electron does not tear itself apart. Coulomb forces hold the electron together. They also prevent it from closing in on itself. As stable as an electron is, it is easily annihilated and converted into photons by combining with an opposite electron. My model thus provides a good explanation for the stability of electrons and the ease of their annihilation.

Where Have All the Positrons Gone?

Positrons are rare birds. We do not see many of them. That is because on earth once produced they almost immediately are attracted to an electron and the two are annihilated. If electrons are produced in pairs in pair production by high-energy photons, and also annihilated in pairs, then there should be an equal number of negatrons and positrons in the universe. In my model there is. The missing positrons are contained in protons. This leads us to my preferred model of the proton that was described fairly well by me in my patent application filed in July 2001.

Protons and Neutrons are Made of Positrons and Negatrons

In the oldest parent to this Application, Applicant speculated that the known universe can logically be described as being comprised of nothing more than electrons (i.e., positrons and negatrons), the negatron having a negative charge −e and the positron having a positive charge of +e, and that the only forces acting in the universe is the electrical forces described by Coulomb's Law, i.e.:

$$F \approx \frac{{q}_{1} {q}_{2}}{{r}^{2}}$$

In the parent case I speculated that, “[E]verything in the universe is comprised of combinations of these two simple point-like charges most of which were created in equal number at the time of the “Big Bang” from the electromagnetic energy released in that event.” (Now I speculate that electrons, along with everything else [including photons and neutrinos] are made of trons; therefore, everything is made of trons.) Protons and neutrons are made of positrons and negatrons (possibly including neutrinos) but not quarks. Atomic nuclei are made up of protons and neutrons. There is no strong force. A proton is a combination of three positrons and two negatrons in which two negatrons are orbiting a positron (at possibly merely a plus tron) at velocities very close to the speed of light and two additional positrons orbit the central three-some further out to define the size of the proton. The Coulomb force holds the positrons and negatrons of the nucleus together and centripetal force and the Coulomb force combine to keep the particles appropriately separated.

The Proton Structure

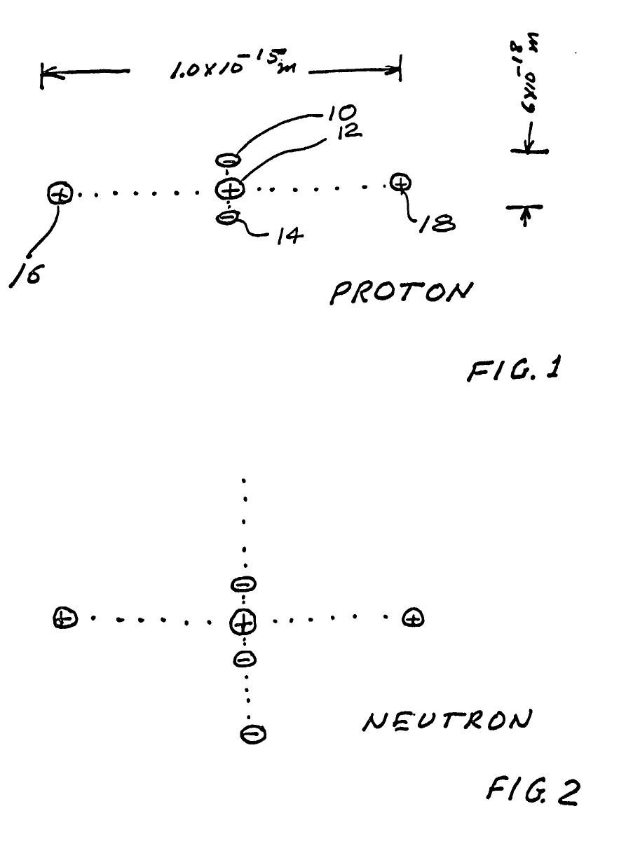

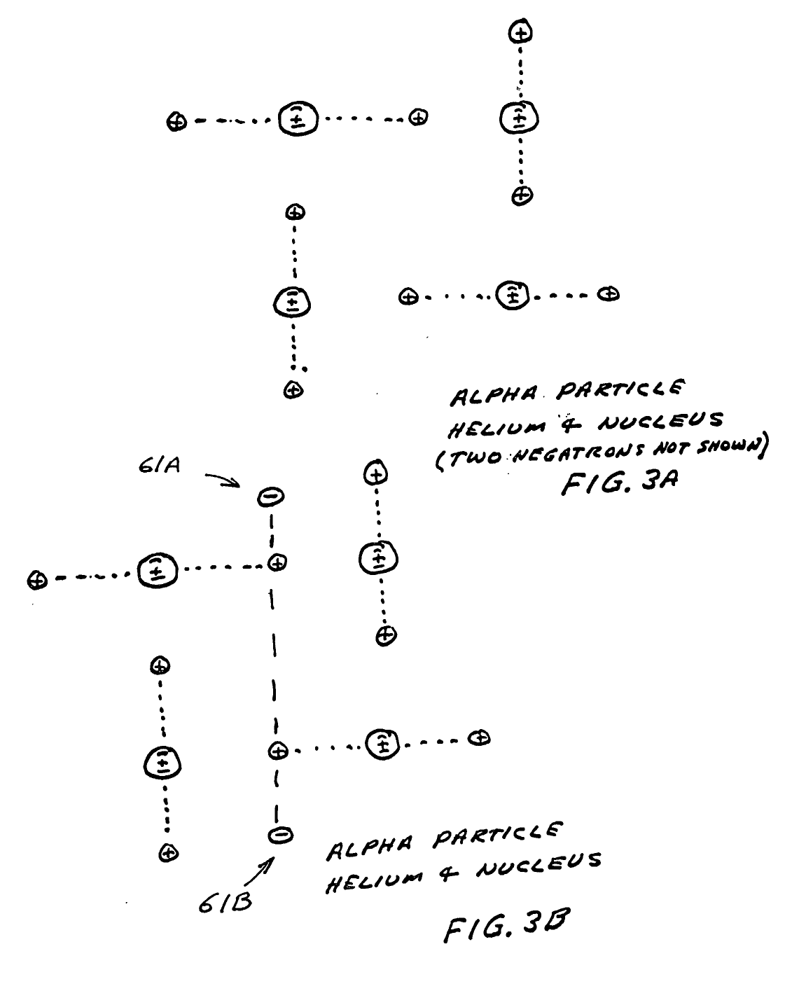

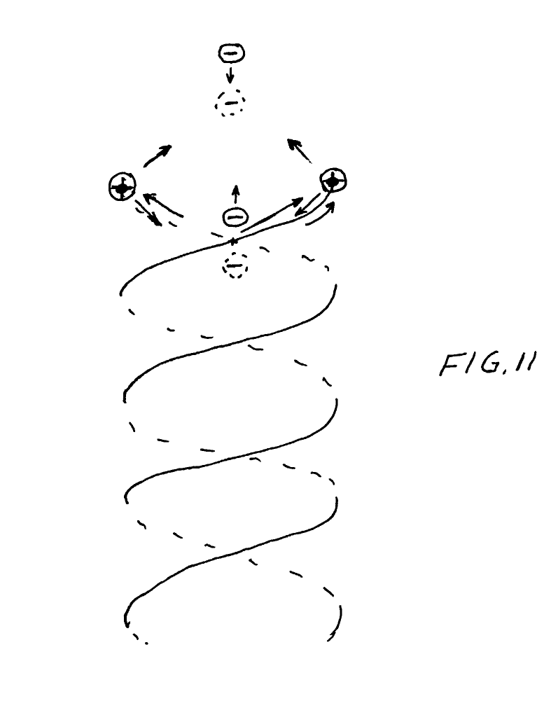

A preferred proton model is proposed that I call the Ross Proton Model. In accordance with this model a proton is comprised of a central three-some consisting of a single positron orbited by two negatrons at extremely large velocities with two more positrons orbiting the central three-some, all as shown in FIG. 1. A neutron has the same general structure as a proton, but an additional electron (as shown in FIG. 2) orbits the two negatrons and three positrons. In the nucleus the neutron's extra electrons are probably shared so that protons and neutrons are probably not distinguishable in the nucleus. As stated in the Background section, it is known that the electron rest mass is about 9.1×10⁻³¹ kg and the reported mass of a proton is about 1.6731×10⁻²⁷ kg and the reported mass of a neutron is about 1.6754×10⁻²⁷ kg. (In alternate models some or all of the negatrons and positrons in each proton and neutron may have a neutrino incorporated in them.) In one specific model created to respond to the results of a proton anti-proton annihilation, all of the trons in each of the orbiting negatrons and positrons in the proton incorporates a neutrino. Neutrinos are further described below. One is shown in FIG. 11. FIGS. 11A, 11B and 11C show how a neutrino can be incorporated into an electron. The reader should recognize that a change of all signs in these figures would show how the opposite neutrino could be incorporated into a positron.

Two Very Fast Moving Negatrons

Most of the apparent mass of the proton and the neutron is accounted for by the two negatrons which are orbiting the center position at a radius of about 3×10⁻¹⁸ m and at a velocity almost equal to the speed of light, i.e., an orbit velocity of about 0.9999994 C which gives each of them an apparent mass of about one half the reported mass of a proton and about one half the mass of a neutron.

Centripetal Force

To estimate the radii of the orbit of one of these two negatrons 10 orbiting positron 12 as shown in FIG. 1, we equate the electrostatic attractive force between the positron and the negatron which is:

$$F = \frac{{q}_{1} {q}_{2}}{4 π {ϵ}_{0} {r}^{2}}$$

and the centripetal force of the very fast orbiting negatron which is:

$$F = \frac{m {v}^{2}}{r}$$

Thus we obtain a rough estimate of r as:

$$r = \frac{{q}^{2}}{4 π {ϵ}_{0} m {v}^{2}}$$

Since

m=½×1.67×10⁻²⁷ kg=0.835×10⁻²⁷ kg,

q=1.6×10⁻¹⁹C

v=0.9999994C, and

¼πe₀=9.0×10⁹ Nm²/C²:

r=3×10⁻¹⁸ m.

At this radius the Coulomb attractive forces between the orbiting negatron and the central positron is enormous:

$$F = \frac{{q}_{1} {q}_{2}}{4 π {ϵ}_{0} {r}^{2}}$$

$$F = 2.5 \times {10}^{7} N$$

The centripetal force is the same:

$$F = \frac{m {v}^{2}}{r}$$

$$F = 2.5 \times {10}^{7} N$$

These calculations are very rough and only produce a general rough approximation of forces and distances. In the above calculations, I have neglected the effects of the second negatron 14 also orbiting the center positron. It has the same velocity as negatron 10 and the forces on negatron are the same as the forces on negatron 14. Negatrons 10 and 14, as they are attracted to positron 12 are repelled by each other with a force of about:

$$F = \frac{{q}_{1} {q}_{2}}{4 π {ϵ}_{0} {r}_{2}^{2}}$$

where r₂ is effective separation of negatrons 10 and 14. A force calculation based of a separation between the two negatrons of about 6×10⁻¹⁸ m would produce a repelling force of about 0.64×10⁷ N. However, both are moving at almost the speed of light. Thus, the Coulomb force exerted by each negatron on each other should be somewhat greater than this since each negatron sees the other as being significantly closer than it really is. The faster the negatrons travel the closer the negatron on the opposite side of their orbit appears.

Thus, the two negatrons orbiting the center positron are repelled by each other with a force equal to at least 25 percent of the attractive force exerted by the positron on the two negatrons. It is this repelling force of the two negatrons acting on each other when added to the repelling centripetal force experienced by each that prevents either of them from spiraling into the positron and annihilating the positron and the first negatron to reach it. It may be that this repelling force creates force wells that established the stable orbits of the two negatrons so close but not too close to the central positron.

These three particles, the center positron 12 and fast orbiting negatrons 10 and 14 have a net charge of −1e and these three particles are orbited by two positrons 16 and 18 at a radius of about 0.5×10⁻¹⁵ m which establish the size of the proton. At this radius the Coulomb attractive force between each of the positrons and the three central electrons (with a net charge of −1.6×10¹⁹ C) is.

$$F = \frac{{q}_{1} {q}_{2}}{4 π {ϵ}_{0} {r}^{2}}$$

$$F = \frac{( 9.0 \times {10}^{9} N {m}^{2} \text{/} {C}^{2} ) {( 1.6 \times {10}^{- 19} C )}^{2}}{{( 0.5 \times {10}^{- 15} \text{m} )}^{2}}$$

$$F = 920 N$$

The positrons orbiting the center three-some must orbit fast enough so that their centripetal force approximately equals the Coulomb forces. Therefore, we can get a rough estimate of that velocity from:

$$F = \frac{m {v}^{2}}{r}$$

$$\text{or:}$$

$$v = \sqrt{\frac{F r}{m}}$$

If the velocity is much less than c, the mass of the positrons can be assumed to be equal to the positron rest mass, so:

v=2.2×10⁸ m/s

This is about 73 percent of the speed of light and as a result the mass would be increased about 50 percent above the rest mass of 9.1×10⁻³¹ kg or to about 13.6×10⁻³¹ kg which means that the velocity is somewhat less than the above estimate, maybe about ½ the speed of light. This model of the proton has the two positrons 16 and 18 orbiting on substantially the opposite side of the center three-some but on different paths. As with the negatrons, the opposing positrons (along with the center positron) help prevent each other from spiraling into the lower orbiting electrons.

Therefore to summarize, the proposed model of the proton is shown in FIG. 1. It consists of a positron at a center position with two negatrons orbiting at a radius of about 3×10⁻¹⁸ m so fast that their combined mass is increased to a mass almost equal to the known proton mass. The two positrons orbiting at about 0.5×10⁻¹⁵ account for the rest of the mass of the proton that totals about 1.7×10⁻²⁷ kg. The orbit of the two positrons also establishes the measured size of the proton. Note that FIG. 1 is not drawn to scale.

The Middle Particle of a Proton May be a Plus Tron

Another slight alternative to the proton model described above is the same model except the middle positron is replaced by a plus tron. Thus, the proton would be made up of a plus tron, two negatrons and two positrons. (An anti-proton would be comprised of a minus tron, two positrons and two negatrons.) The plus tron has the same charge as the positron and in terms of the mass of the proton about the same mass (i.e., 9.1×10⁻³¹ kg as compared to 0 kg). One recently published physics book, (see Fundamentals of Physics, Extended, Halliday, Resnick and Walker, John Wiley & Sons, pages 1120-1123) described the residue of a proton and anti-proton annihilation as producing four positive pions and four negative pions. These pions ultimately (in fact, very quickly) decay first to muons which in turn decay into four negatrons and four positrons, with the release a total of of 24 neutrinos. Therefore, in alternative models I have permitted each orbiting positron and each orbiting electron in each proton and each anti-proton (a total of 8 orbiting electrons) to have captured three neutrinos each (for a total of 24 neutrinos being captured). The capture of a neutrino does not change the charge because the neutrino's net charge is zero. Arguably, it does not change the mass significantly because the neutrino is suppose to have zero mass or almost zero mass. However, an electron or positron with three neutrinos in it (three neutrinos with four trons each are comprised of a total of 12 trons) orbiting at near the speed of light may be an important factor in developing the effective mass of both the proton and the neutron. This would mean that the close-in orbiting electrons may not have to go so close to the speed of light as described above in order to produce the proton mass.

Quarks

The reader may be wondering at this point how the Ross Proton Model squares with existing proton models. Accelerator experiments show that the proton can be broken apart. When this happens very short-lived particles are produced which decay into positrons and negatrons (plus photons and possibly neutrinos). The Ross Model is supported by this data. This experimental data also indicates (assuming the Ross Proton Model is correct) that the three central electrons are not stable by themselves. That is, they need the two orbiting positrons to help hold them in their very fast path around the central positron. Quarks are supposed to have charges such as +2e/3 and −1e/3. The Ross Proton Model does not need quarks to explain the construction of protons (or neutrons as explained below). I suspect that Quarks don't exist.

Neutrons

The Ross Neutron Model is merely a proton with an electron orbiting it. The measured mass of a neutron is greater than the combined mass of a proton and an electron by about 15×10⁻³¹ or about 160 percent of the mass of an electron. This difference can be accounted for by an increased mass associated with an electron velocity of about 0.78 c. This would imply an orbit close to the orbit of the outer two positrons in the Ross Proton Model. Alternately, the electron orbit might be farther out but its presence may cause the two electrons to orbit faster to produce the missing mass. Also, the electron may have captured one or more neutrinos as explained below. The neutron is not stable, having a half-life of only about 15 minutes. The Ross Neutron Model is shown in FIG. 2. When neutrons are part of a nucleus their extra electron is probably shared more or less equally with the protons in the nucleus.

Neutron Modeled as a Proton plus an Electron plus a Neutrino

In a preferred model a neutron is modeled as a proton plus a “heavy electron”. This heavy electron is an electron which has captured a neutrino. The logic for this is very simple. A neutron decays to a proton by emitting an electron plus a neutrino. It certainly makes sense therefore that a neutron consists of these three things. In another model each tron in the electron may incorporate a neutrino.

Atomic Models

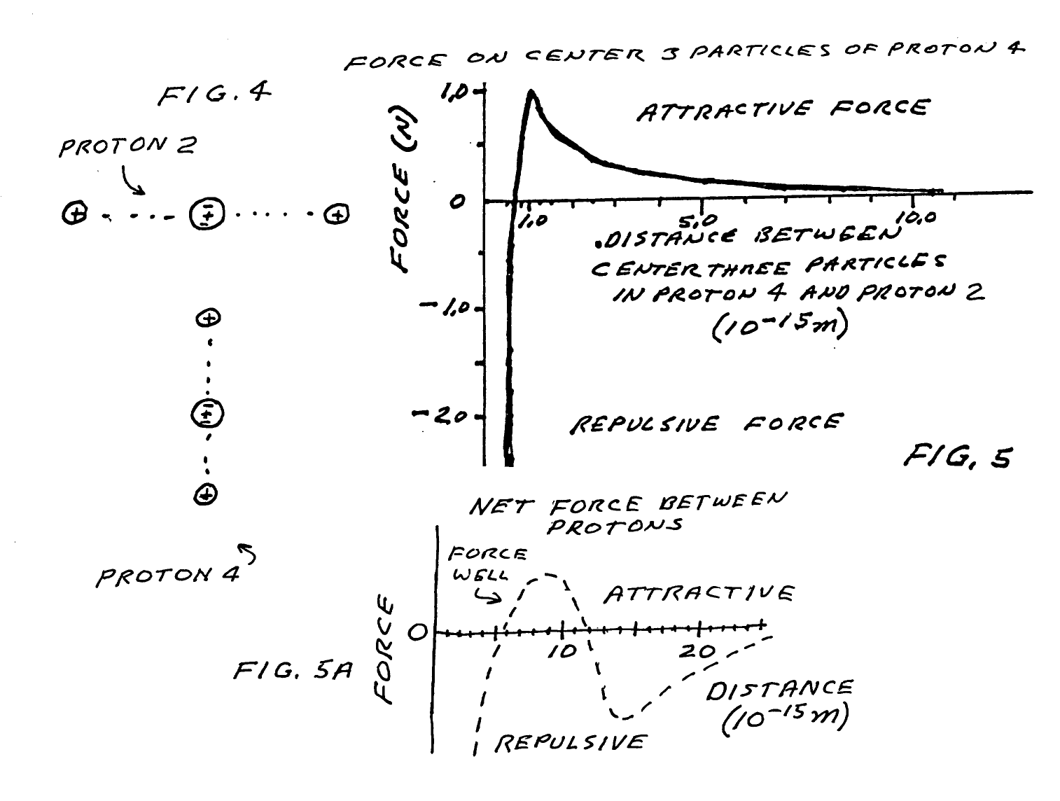

FIG. 3A shows a suggested arrangement of components of a helium 4 nucleus or an alpha particle according to the Ross Nuclear Model with the two extra negatrons (associated with the two neutrons of the helium nucleus) not shown. In this description, I will refer to the group of three positrons and two negatrons shown as shown in FIG. 1 as a “proton” recognizing that the group could have at least initially existed as a neutron with an extra electron orbiting as described above. This liberty is the result of my belief that a neutron (if it is ever identifiable as a separate entity in a nucleus can change places with a proton by having its outer negatron be stolen by a neighboring proton. The missing two negatrons in the FIG. 3A drawing are the outer negatrons of what the prior art refers to as the two neutrons in the nucleus of the helium atom or the alpha particle. Neutrons and protons each appear as five electrons, one positron at the center orbited closely at 3×10⁻¹⁸ m by two negatrons, with this threesome being orbited at 0.5×10⁻¹⁵ m by two positrons. The two extra negatrons are shown FIG. 3B at 61A and 61B in a close-in more or less arbitrary orbit around a central position of the four “protons”. Many orbits of the two negatrons are possible. For example, the negatrons could orbit a single proton or they could orbit any combination of the four protons.

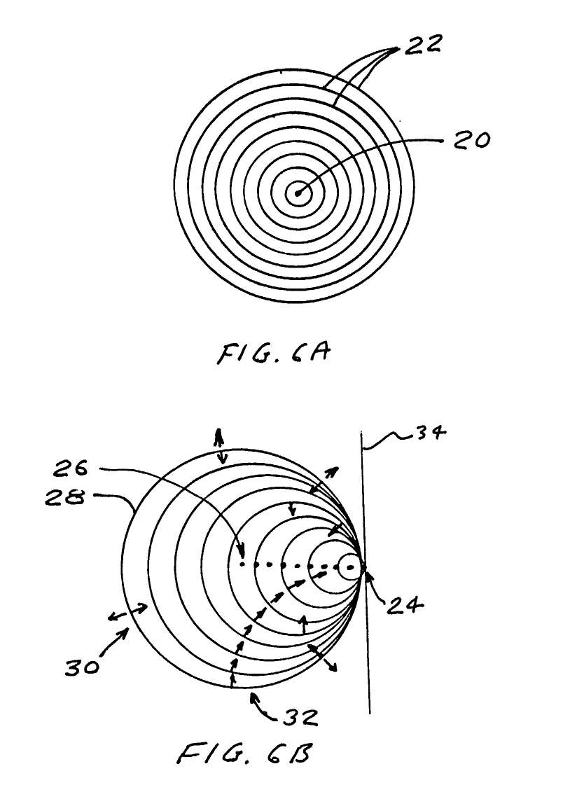

So now let us estimate the forces acting on the protons in this configuration. Remember, the prior art thinking has been that some mysterious God-like “strong force” (which no one could very well explain) must be acting to hold the positive charged protons together in the nucleus. To get a feel for the forces between these protons, let's just consider the forces between the two protons on the left side of the FIG. 3A diagram. These two protons are reproduced in FIG. 4. In FIG. 4 the central positrons and the close-in orbiting negatrons appear as small circles, each with a plus and two minus signs in it. On any scale showing the two inner orbiting negatrons (orbiting at 3×10⁻¹⁸ m) and the two orbiting positrons (orbiting at 0.5×10⁻¹⁵ m) the three inner particles would appear as a tiny spot with a charge of −e while the two orbiting positrons appear as two orbiting spots each with a charge of +e.

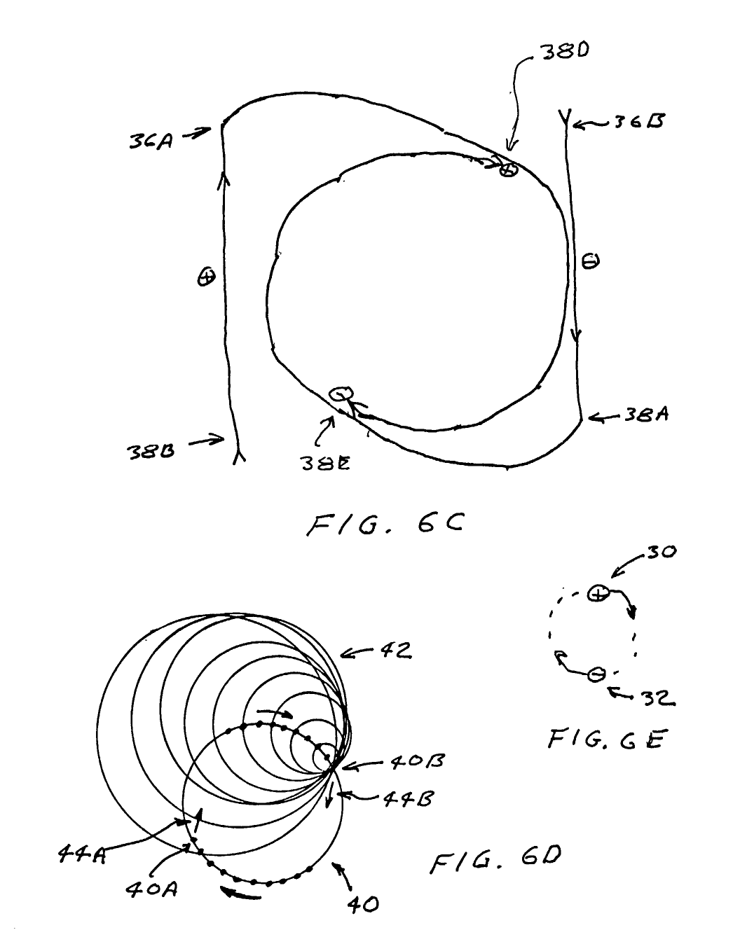

So on with the Coulomb force calculation. (Remember from the Background section we reported that the prior art thinking was that the Coulomb force between two protons in a larger nucleus separated by 4×10⁻¹⁵ m was a repelling force of 14 N.) However, a close examination of FIG. 4 suggests that with the two protons arranged as shown, with the orbiting planes of the two orbiting positrons of each proton at right angles to each other, at certain distances the net forces of the particles making up the two protons could be attractive at certain ranges of separation and repelling at other ranges. For example at long separations (i.e., very long compared to the dimensions of the protons), the force acting between the protons is repelling since both have a net charge of +e. At very close separation, the closest positron of proton 4 will feel an attraction to the central three particles of proton 2 that is greater than the repulsion to the two orbiting positrons of proton 2. However, as the closest positron of proton 4 moves away from its position shown in FIG. 4, the repulsion from the orbiting positrons of proton 2 will exceed the attractive force of the central three particles of proton 2. Therefore, in the close position, the orbiting positrons of proton 4 will be both attracted and repelled as they make their orbits. The forces acting on the central three particles of proton 4 however would appear to be much more important in determining a stable position of proton 4 relative to proton 2 since their effective mass is about 1000 times greater than that of the orbiting positrons of proton 4. At long distances the central 3 particles of proton 4 feel a net attraction to proton 2, since the central 3 have a net negative charge and the net charge of proton 2 is positive. The closer proton 4 gets to proton 2 the stronger is the attraction of the central three particles of proton 4 to proton 2. However, once the central three particles of proton 4 approach very close to the central three particles of proton 2, the repulsive force due to the central three particles of proton 2 overcome the attractive force of the two orbiting positrons of proton 2 and the force from proton 2 acting on the central three particles of proton 4 becomes repulsive. Therefore, a “force well” is created between the particles of proton 2 and the central 3 particles of proton 4. Once the central three particles of proton 4 are in this well they cannot easily escape. I estimate for example that at a separation of about 0.5×10⁻¹⁵ m between the three central particles of the two protons, the central three particles of proton 4 are very strongly repelled from proton 2, but from about 0.7×10⁻¹⁵ m to about 5×10⁻¹⁵, the central three particles of proton 4 are very strongly attracted to proton 2, with the strongest attraction at a separation of about 1×10⁻¹⁵ m. The orbiting positrons of proton 4 do not like being so close to the orbiting positrons of proton 2, but they are very light as compared to the central three particles so they are not very determinative of the position of proton 4. Their orbits will be substantially altered from circular as a consequence of the pushing and pulling from the particles of proton 2 as the positrons of proton 4 make their many very quick journeys around the central three particles of proton 4. FIG. 5 is a graph of my very rough estimate of the forces acting between the particles of proton 2 and the central three particles of proton 4.

Calculation Example

The following is a calculation to estimate the attractive force acting between the central three particles of proton 4 and the particles of proton 2 when the central three particles of proton 4 are located 1×10⁻¹⁵ m from the orbit plane of proton 2. The net force is difference between: (i) the attractive force between central three particles of proton 4 and the two orbiting positrons of proton 2 and (ii) the repulsive force between the central three particles of proton 2 and the central three particles of proton 4.

Force Exerted by the Particles of Proton 2 on Central Three Particles of Proton 4 When the central three particles of protons 2 and 4 are separated by 1.0×10⁻¹⁵ m, the central three particles of proton 4 are separated from the proton 2 orbiting positrons by about 1.12×10⁻¹⁵ m and each of these positrons attract the three central particles of proton 4 at an angle of 26.5 degrees with the orbit axis of the positrons. (These estimates are based on the assumption that the orbits of the proton 2 orbiting positrons are not changed very much due to the presence of proton 4.) The cosine of 26.5 degrees is 0.894. Thus, the attractive force from proton 2 (due to the pull of the orbiting positrons) on the central three particles of proton 4 in a direction toward the central three particle of proton 2 is:

$$F = \frac{2 {q}_{2} ( 0.894 )}{4 π {ϵ}_{0} {r}^{2}} = \frac{( 2 ) ( 9.0 \times {10}^{9} N {m}^{2} \text{/} {C}^{2} ) {( 1.6 \times {10}^{- 19} C )}^{2} ( 0.894 )}{{( 1.2 \times {10}^{- 15} \text{m} )}^{2}} = 326.9 N$$

The repulsive force (due to the repulsive force between the center three particles of the two protons) is:

$$F = \frac{{q}_{2}}{4 π {ϵ}_{0} {r}^{2}} = \frac{( 9.0 \times {10}^{9} N {m}^{2} \text{/} C ) {( 1.6 \times {10}^{- 19} C )}^{2}}{{( 1.0 \times {10}^{- 15} \text{m} )}^{2}} = 230.4 N$$

The net force is:

F=+326.9−230.4=+96.5 N

that is a very strong attractive force.

As indicated above and shown on FIG. 5 if proton 4 approaches proton in the direction shown in FIG. 4, the center three particles of proton 4 will be strongly attracted to proton 2 until the center three particles are within about 1×10⁻¹⁵ m of proton 2 at which time the attraction drops sharply and at about 0.6×10⁻¹⁵ m the center three particles are repulsed. FIG. 5 as stated above neglects the effect of the proton 4 positrons which feel a net repulsive force from proton 2. Thus, proton 4 will quickly find its net zero force location somewhere around 6×10⁻¹⁵ m from the center of proton 2 as indicated in FIG. 5A and will probably oscillate about that zero force position at a very large frequency.

The other protons of the helium nucleus will arrange themselves in a similar configuration, a possible configuration being the one shown in FIGS. 3A and B. The atoms heavier than helium will have their protons arranged in a manner similar to that shown for helium. It should be relatively easy for persons skilled in this art to construct computer models which would model the Coulomb forces of these particles and would predict the shape of these nuclei including the helium nuclei much more accurately than I have done here with my very simple calculations. These calculations are not intended to be precise. Persons skilled in the art of nuclear physics will be able to greatly improve on my extremely rough calculations. The purpose of these calculations is merely to show that there are potential configurations of positrons and negatrons which can account for the mass, size and charge of protons and neutrons, and that there are configurations of protons and neutrons (made up of positrons and negatrons, which in turn are made up of plus and minus trons) based on this model that can explain the structure of atomic nuclei.

Magnetism and Gravity

Preferred models of the present invention predict that the only forces in the universe are the Coulomb forces produced by trons. This means that there is no independent magnetic force and no independent gravitational force, and that these well-known forces are only manifestations of the tron Coulomb forces. I have not been able to derive the magnetic forces and the gravitational forces from this model; however, I have developed some very qualitative speculation as to possible connections.

Magnetism

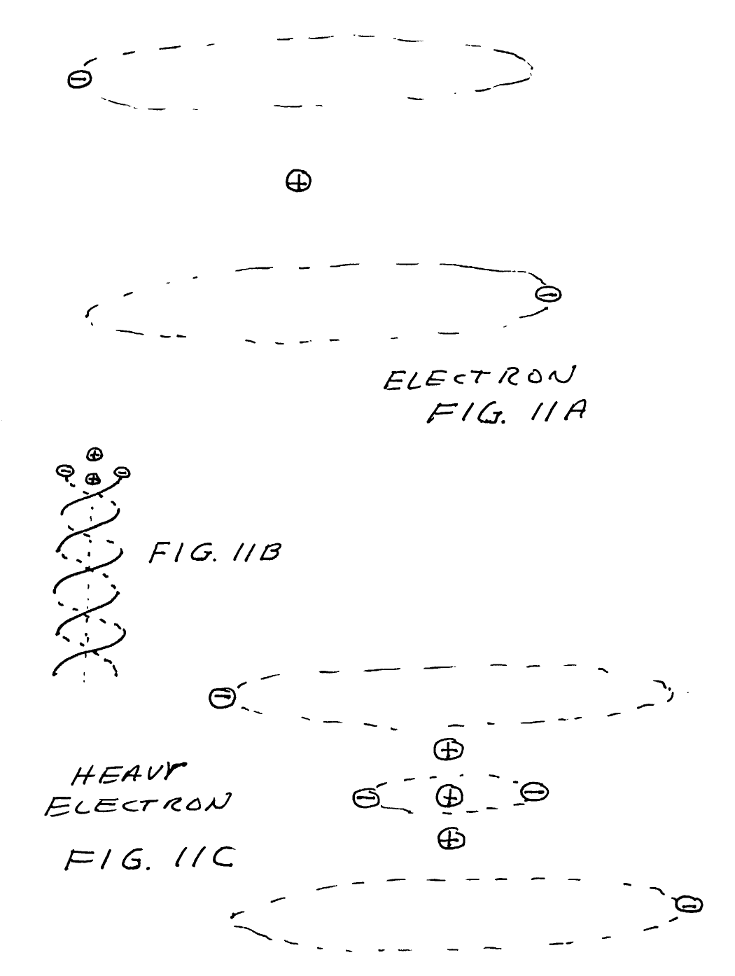

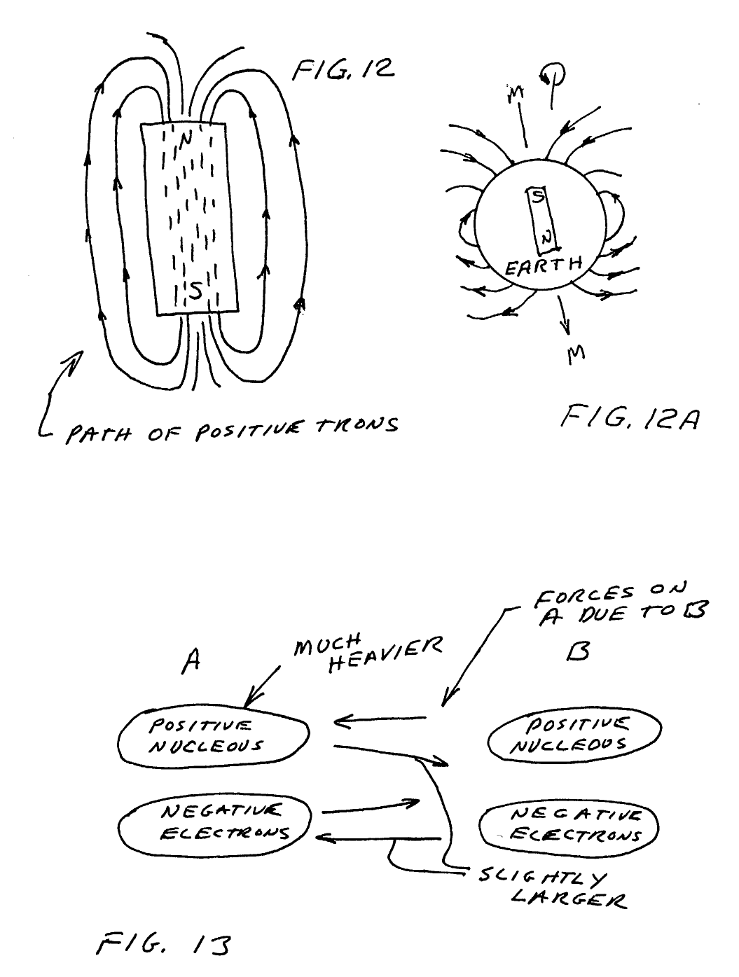

As to magnetism, see FIG. 12. All matter except possibly at extremely low temperatures are loaded (according to preferred models of the present invention) with unattached positive and negative unattached trons, most of which are whipping around a speeds in excess of the speed of light (such as 9×10⁸ m/s). In most cases the motions of these trons are random. The trons pass freely into and out of the matter. Applicant speculates that when a magnet is formed, either permanent or an electric, trons are forced to travel along specific routes as shown in FIG. 12. Applicant speculates that a result of this organized flow of these mass-less charged particles, magnetic forces are produced. These trons flow through the earth (according to this model) into the earth near one pole and out of the earth near the other pole to produce the earth's magnetic field as shown in FIG. 12A. This may seem like a long way to go but remember these trons can haul buggy at 9×10⁸ m/s. So the round trip around and through the earth with its 6.37×10⁶ m radius might take less than one second. Amazing!

Gravity

The force of gravity according to Newton is:

F=GM₁M₂/r²

Where G=6.67×10⁻¹¹ Nm²/kg².

So the 6×10²⁴ kg earth with a radius of 6.37×10⁶ m exerts a force on my 68 kg body of:

F=6.7×10² N

The earth has according to my extremely rough calculations about 4×10⁵¹ negative electrons orbiting in the atoms making up the earth. I have about 4×10²⁸ protons in the nuclei of the atoms making up my 68 kg body. The attractive force of the earth's orbiting electrons on the protons in my nuclei is about:

F=(9×10⁹ Nm²/C²)Q₁Q₂/r²

where the Qs represent the total charges of the above electrons and the protons; therefore,

F=9×10³⁸ N.

Similar calculations can be made for the attraction between my electrons and the earth's protons and the repulsive forces between my electrons and the earth's electrons and my protons and the earth's protons. There is an extremely widely held general belief that these absolutely enormous forces are completely nullified by each other. This may be true; however, it may also be true that the electrostatic forces do not completely balance. And that for distances larger than atomic distances and shorter than galactic distances, this lack of complete balance in the electrostatic forces results in the force we have, since Newton's time, called the force of gravity. (As explained in detail above, this lack of complete balance of electrostatic forces has allowed me to propose a Coulomb substitute to the nuclear “strong” force at nuclear distances.) There may not be a complete balance at distances of meters, to solar distances where we can clearly see the effects of the force we call gravity. I note here that astronomers have collected evidence that stars in the outer reaches of galaxies do not seem to be moving consistently with the rules of gravity. The normal explanation is that there is matter in the galaxies that we can not detect. Another explanation is that at galactic distances and beyond our old gravity rules don't work. This may also explain why galaxies do not normally attract each other.

We know that the galaxies of the universe are receding from each other but we do not know why. My speculation is that they are being pushed apart by the force of photons and neutrinos coming from other galaxies. When the stars of the various galaxies are sufficiently burned out these photons and neutrinos will be reduced to a level at which the galaxies will begin to attract each other. This may be the beginning of the next big bang!

Implications of the Ross Nuclear Model

The structure of protons, neutrons, nuclei, atoms, the earth, us and the rest of the universe can be explained very simply without resort to the strong force, quarks and other prior art theories of “modern physics” that the leading writers apparently believe in without proof of their existence. This model also, better than any other example that I am aware of, shows that mass and energy really are the same thing! Positrons and negatrons are generated from high-energy photons that have energy, a velocity of c but no mass. We also know that when a positron and a negatron collide both may be annihilated with the production of two high-energy gamma rays. Protons and neutrons are, in the Ross models, nothing but combinations of these positrons and negatrons with possibly some neutrinos thrown in. Two of the negatrons are moving extremely fast, fast enough to produce almost all of what we have thought of as the mass of these particles. So in protons and neutrons the masses of electrons and positrons are amplified. But, based on this model, electrons and positrons are made from mass-less things (trons) which develop their mass when subjected to conflicting forces created by the trons them selves and each other. Atoms are made of protons and neutrons along with some orbiting negatrons and all of the things we see in the universe are made of atoms. Thus, all the mass of the things we see in the universe is derived from the electrostatic forces generated by these mass-less trons and applied to themselves and each other.

This model also is consistent with the notion that for each negatron, there must be a positron. In my model the universe has exactly the same number of negatron as positrons. My preferred models also propose the exact same number of plus trons and minus trons. With this model, believers will have a good time revising theories dealing with the big bang. It is very easy to understand how the energy released in the big bang would have created billions and billions and billions of equal numbers of positrons and negatrons each which quickly would have quickly annihilated one of its opposites or would have combined with four other electrons to form a proton or five other electrons to form a neutron. The protons are extremely stable. Most of them would have at some time captured a negatron to form a hydrogen atom. The neutrons would either have combined with a proton or would have quickly decayed to a proton.

Big Bang Speculation

Believers also will find it fun to explain the origin of the last big bang and to predict the next big bang. Since we now understand the basic structure of nuclei, we can understand what will happen when all the matter of the universe comes crushing in to almost a single point. This is possible since trons are points, since there are equal numbers of them and since opposite trons love each other. Think of the fun we will have calculating the energy released when all of these positrons and negatrons of all the atoms of the known universe are crushed together and annihilate each other. For example:

Prior to the big bang there existed an earlier universe similar to ours. After trillions of years, all of the stars burnt out and cooled down stopping a previous expansion and starting a contraction toward the biggest black hole in the universe which was an enormous neutron star comprised of neutrons and trapped neutrinos. As long as the black hole was eating the rest of the universe, the energy produced kept it from collapsing in on itself. However, when essentially all of the universe had been consumed this biggest of all black holes began to collapse in on itself converting its neutrons to neutrinos and anti-neutrinos all of which headed directly for the center of the black hole converting neutrons to neutrinos and anti-neutrinos on the route all of which head to the center of the black hole. At the center the neutrinos and anti-neutrinos combine in a volume the size of a softball to produce the big bang in which a large portion of the trons making up the neutrinos and anti-neutrinos are released as plus and minus trons all of which expand out from the center of the big bang pushed by their own repulsive forces at speeds equal to or greater than 3 c.

If the Ross Proton Model is correct, it should be apparent that the proton (the hydrogen nucleus) has within it one heck of a lot of energy orbiting around. Therefore, we may want to put some effort into trying to figure out how to release that energy. The energy available is many orders of magnitude greater (for a given amount of hydrogen) than that released in a hydrogen bomb. The current belief is the in a hydrogen bomb two hydrogen nuclei are converted to a helium nucleus. The energy released is the difference in mass of the two hydrogen nuclei and the mass of the helium nucleus. This is a small fraction of the mass of a hydrogen nucleus. If this model is correct all (or almost all) of the mass of the hydrogen nucleus would be released if we could cause it to break apart. If we could knock off one of the orbiting positrons, the remaining particle would probable be unstable and decay rapidly into positron and negatrons flying apart at high speeds or annihilating each other along with the release of gamma rays.

Correctness of Models

The models presented in this specification (including the proton and the model of atomic nuclei presented above) constitute a major departure from the most widely accepted theories explaining the makeup of nuclear particles. If the Ross models are anywhere close to being correct all physics books written during the past 20 years will have to be substantially revised. Applicant recognizes that many of the smartest people in the world have devoted their lives to efforts directed at explaining the makeup of these nuclear particles. If the above models are correct, Applicant finds it very difficult to believe that at least one of those brilliant people would not have developed them long ago. Nevertheless, Applicant has described his models in the very long shot belief that they might be correct or that they are close to correct. Applicant has presented his nuclear model as a patent application for two reasons: (1) he is a patent attorney (a long time ago he used to be a nuclear engineer) and is familiar with patent applications as a technique for publishing discoveries, (2) a patent application is at least initially kept secret and can be abandoned, or corrected in continuations-in-part so if he learns soon that he has made foolish mistakes, he can perhaps minimize his embarrassment and (3) in the unlikely event he his right, he wants to have some control over the applications of his discoveries. For example, all of his current and past clients will have a royalty-free right to practice (in their current business activities or in any current or past anticipated research and development) under any resulting patent.

Processes for Testing and Evaluating Ross Proton Model and Ross Nuclear Model

Many processes for utilizing, testing and evaluating the Ross Proton Model, the Ross Neutron Model and the Ross Nuclear Model are available. One process is for a person experienced in modern nuclear physics to evaluate the models as they have been presented in this specification. This can easily be accomplished with a hand calculator.

Computer Models

A more sophisticated model would be to utilize a digital computer model incorporating one or more of the Ross models. It should be fairly simple to model the trons, the positrons the negatrons the protons and neutrons in the Ross Proton Model and determine which are stable. If I am right, these models will show that the Ross electron and proton and their antiparticles should be enormously stable except when opposites meet. By making the computer model a little more complicated, it should be feasible to determine how hard it would be to make a proton using the technique described above for doing that. Perhaps then the computer model could be extended to predict the formation of protons in the Ross model during the process that followed the big bang. Once the Ross proton and the Ross neutron have been modeled on a digital computer it would be relatively simple to create similar computer models to examine the Ross Nuclear Model. After these models are created investigations could be preformed to determine if a technique can be developed to breakup the proton and release its energy. If this could be done economically, we would have what may be the most important invention since the beginning of civilization.

Nuclear Tests and Experiments

If computer modeling shows that the Ross models are correct or that modifications or derivations of the Ross models are correct. A next step is to perform some experiments with particle accelerators to test the models or aspects of the models. It may be that current accelerators do not have the capabilities to properly investigate the Ross models. If so and if the models are shown to be possibly correct then perhaps accelerators can be built to properly test the models. Actually, since the filing of the parent to this Application, Applicant has read that already experiments have been conducted in which positrons and negatrons were fired at each other each with high energy and the result was protons! Also, as referred to above, experiments have been reported in which the annihilation of protons and anti-protons produced electrons and positrons. We have known for many years that electrons and positrons can be produced for photons and that the annihilation of electrons and positrons produce photons. All of these experiments support the models described above.

Trons Deserve Their Own Unit

Applicant believes that if his model is correct and the entire universe is made of these trons, each having a particular charge approximately equal to the values set forth above; the magnitude of that charge should be considered one of the most important things in the world—important enough to rate its own value. And also the other forces at work in the universe all of which will be, one way or other, derived from these charges should be spoken of in terms of the quantity of these charges and not vice versa. Applicant has thus generated a new term that represents the exact magnitude of the charge of a tron. That term is the “Ross” the symbol for a Ross is “R”. Thus, the charge of a plus tron is +1 Ross or +1R. The charge of a minus tron is minus 1 Ross or −1R. The plural of Ross is Ross (like the plural of deer is deer). Therefore, one Coulomb is equal to about 6.25×10¹⁹ R. Since force between charges is the product of the two charges divided by the square of the distance between them, force is expressed as Ross per square meter (R²/m²). Thus, the attractive Coulomb force between a plus tron and a minus tron positioned 5.3×10⁻¹¹ meter apart is equal to 3.56×10²⁰ R²/m². That force in Newtons is 8.2×10⁻⁸ N; thus, one Newton equals 4.34×10²⁷ R²/m².

No Quarks, No Special Weak Force and No Strong Force

This model shows how nuclei can be held together by Coulomb forces which unquestionably exist. Therefore, there is no need to invent nuclear forces for which there is no proof of existence such as the special weak nuclear force and the strong nuclear force. Also, since the above model shows how protons and neutrons can be held together in the nuclei of atoms there is no need to invent quarks for which there is no good experimental evidence.

While preferred embodiments of the present invention are described above, the reader should not construe the present invention as limited by the above description. In fact persons skilled in nuclear physics will envision many other possible variations within the scope of the present invention. For example, other models of proton, somewhat more complicated than the one described above may be the true proton model. For example, instead of two negatrons in the close-in orbit there could be four or six with a corresponding four or six positrons in the outer orbit, again to give the proton a plus 1 charge. The basic Ross Proton Model is a proton that is comprised of only electrons, the electrons including a plurality of positrons and a plurality of negatrons, with at least one of said electrons orbiting at least one other of said electrons at a velocity great enough to increase the mass of electrons to equal a proton mass of about 1.67×10⁻²⁷ kg. Processes involving many other branches of physics will need to be revised for a correct understanding of the true nature of the atomic structure. The above disclosures may also be useful in processes for analyzing electromagnetic radiation, especially high-energy radiation. Accordingly, the reader is requested to determine the scope of the invention by the appended claims and their legal equivalents and not by the above examples.

I claim:

1. A process for modeling elements of the universe utilizing in models negatively charged things, hereinafter called minus trons, each having zero rest mass and a negative charge of about 1.9×10⁻¹⁹ Coulomb and positively charged things, hereinafter called plus trons, each having zero rest mass and a positive charge of about 1.9×10⁻¹⁹ Coulomb, said process comprising:
A) assigning an electric force field to each plus tron which expands out spherically from each of said plus tron with a specific velocity substantially in excess of the vacuum speed of light and produces an attractive Coulomb force on each minus trons and a repulsive Coulomb force on each plus trons,
B) assigning an electric force field to each minus tron which expands out spherically from each of said minus tron with a specific velocity substantially in excess of the vacuum speed of light and produces an attractive Coulomb force on each plus trons and a repulsive Coulomb force on each minus trons,
C) allowing some or all or said trons to be repulsed by their own force fields and to be repulsed and attracted by force fields from other trons so as to attain velocities equal to or greater than said specific velocities substantially in excess of the vacuum speed of light, and
D) using said plus trons and said minus trons to model elements of the universe.

2. The process of claim 1 wherein said specific velocity of said expanding force field is three times the vacuum speed of light.

3. The process of claim 1 wherein everything in the universe is comprised of said plus and minus trons.

4. The process of claim 1 wherein at least one photon is modeled as being comprised of one plus tron and one minus tron traveling together with each tron being pushed by its own force field and attracted by the force field of the other tron.

5. The process of claim 4 wherein said trons are modeled as traveling in a double helix pattern.

6. The process of claim 2 wherein at least one photon is modeled as being comprised of one plus tron and one minus tron traveling in a double helix pattern with each tron being pushed by its own force field and attracted by the force field of the other tron.

7. The process of claim 1 wherein at least one neutrino is modeled as being comprised of two plus trons orbited by two minus trons.

8. The process of claim 1 wherein at least one neutrino is modeled as being comprised of two minus trons orbited by two plus trons.

9. The process of claim 1 wherein at least one negatron is modeled as being comprised of a plus tron orbited by two minus trons.

10. The process of claim 1 wherein at least one positron is modeled as being comprised of a minus tron orbited by two plus trons.

11. The process of claim 1 wherein at least one proton is modeled as being comprised of nothing but trons.

12. The process of claim 1 wherein at least on proton is modeled as being comprised of a central element having a plus charge, at least two negatrons in a close orbit about said central plus charge at speed extremely close to the vacuum speed of light and at least two positrons orbiting said central plus charge and said two negatrons in a farther out orbit.

13. The process of claim 12 wherein said central element comprises a positron.

14. The process of claim 12 wherein each of said negatrons is modeled as having three neutrinos in orbit with it and each of said positrons is modeled as having three neutrinos in orbit with it.

15. The process of claim 12 wherein at least one neutron is modeled as being comprised of said proton plus a negatron.

16. The process of claim 15 wherein said negatron is a heavy negatron which is a negatron having captured a neutrino.

17. The process of claim 15 wherein a nucleus of an atom is modeled as being comprised of protons and neutrons held together with Coulomb forces.

18. The process of claim 1 wherein a magnetic force is modeled as being produced by the flow of trons into and out of magnetic material.

19. The process of claim 18 wherein the magnetic material is the core of the earth and the trons are modeled as flowing into and out of the earth at locations near the north and south poles.

20. The process of claim 1 wherein the entire universe and its evolution before and after the big bang is model using only plus and minus trons as building blocks.

21. The process as in claim 12 wherein said central element is a plus tron.

22. The process as in claim 1 wherein gravity is modeled as a slight imbalance of Coulomb forces.

23. The process as in claim 1 wherein galaxies are modeled as being pushed apart from one another by neutrinos and photons.
